(19) United States
(12) Patent Application Publication
(10) Pub. No.: US 2016/0063873 A1
(43) Pub. Date: Mar. 3, 2016

(54) SYSTEM AND METHOD FOR INTEGRATED LEARNING

(71) Applicant: Enable Training and Consulting, Inc., Milton (CA)

(72) Inventors: Benjamin Jeremy Zimmer, Milton (CA); Octavian Ciubotariu, Kitchener (CA)

(21) Appl. No.: 14/839,291

(22) Filed: Aug. 28, 2015

Related U.S. Application Data
(60) Provisional application No. 62/043,472, filed on Aug. 29, 2014.

(51) Int. Cl. G09B 5/02; G06Q 20/10; G06Q 50/20; G09B 7/00

(52) U.S. Cl. CPC G09B 5/02; G09B 7/00; G06Q 20/10; G06Q 50/20

(57) ABSTRACT

Systems, methods and computer-readable media are provided for interactive learning. A system including one or more modules for content authoring/creation; implementing a student experience; performing lab management & analytics; and supporting a content marketplace is provided. Corresponding methods and computer-readable media are also provided.

### RELATED APPLICATIONS

This application is a non-provisional of U.S. patent application Ser. No. 62/043472, filed 29 Aug. 2014 and entitled “SYSTEM AND METHOD FOR INTEGRATED LEARNING,” and claims all benefit, including priority, of that application, which is incorporated by reference.

### FIELD

The embodiments described herein relate generally to learning platforms, and more particularly to systems and methods for managing interactive learning.

### INTRODUCTION

A challenge facing educators and administrators developing various learning environments is the effective engagement of users. Investment into systems may be resource and time intensive, with varying results on learning outcomes.

Educational institutions may be adopting learning management system (“LMS”) technology for student and course management; however, many institutions are only using an on-line document repository. In many cases, content and/or systems have not been designed to take advantage of various multimedia and other technologies.

As a result, students are often simply accessing Microsoft Word™ documents, Microsoft Powerpoint™ presentations and portable data format (PDF) files through an online portal, and in some cases, downloading the files to their local systems.

### SUMMARY

The present disclosure relates to a system and method for managing interactive learning.

In an aspect, a system configured to administer one or more remote integrated learning environments is provided, the system having one or more processors, the system comprising: an administrative interface unit configured for communication with a first set of remote computing systems being utilized by one or more administrators; a student user interface unit configured for communication with a second set of remote computing systems being utilized by one or more students; an integrated learning environment unit configured to interoperate with the administrative interface unit and the student user interface unit, the integrated learning environment unit including a set of instructions stored on non-transitory computer readable media, the set of instructions adapted to cause the one or more processors to: receive electronic instructions representative of learning materials from the administrative interface unit; automatically parse the electronic instructions to extract a plurality of steps to be performed by the one or more students, each step of the plurality of steps having linkages to at least one other step, the linkages indicating progression between the steps of the plurality of steps, the electronic instructions including at least graphical information to be displayed through the student user interface unit for each step of the plurality of steps; automatically provision, to the student user interface unit, one or more remote integrated learning environments having at least the plurality of steps, the one or more remote integrated learning environments provided for use by the one or more students through the student user interface unit, each of the plurality of steps triggering the provisioning of a corresponding state by the student user interface unit; track, using a timer, one or more elapsed times, each of the elapsed times corresponding to an amount of time the student user interface unit has remained in a corresponding state; based on the linkages between the steps of the plurality of steps, switch between the steps of the plurality of steps when sufficient indications of progress are received through the student user interface unit, triggering changes of state by the student user interface unit; provide a series of visual indicators, each of the visual indicators indicative of each step of the plurality of steps; provide, in a first format, a visual indicator of the series of visual indicators associated with a current step being provided by the student user interface unit; and provide, in a second format, visual indicators of the series of visual indicators associated with steps already traversed by the student user interface unit.

In another aspect, the linkages provide a non-linear progression through the plurality of steps.

In another aspect, the student user interface unit is configured to provide just-in-time help through the student user interface unit.

In another aspect, the just-in-time help is provided when the student user interface unit receives a request for help.

In another aspect, the just-in-time help is provided through the administrative interface unit.

In another aspect, the just-in-time help is provided when the student user interface unit determines that the student user interface unit has remained in a state beyond a pre-defined threshold of time.

In another aspect, the system includes an automated grading unit, the automated grading unit configured to: receive an electronic instruction from the administrative interface unit to generate one or more grade reports; automatically generate the one or more grade reports, each of the grade reports including grades based at least on the one or more elapsed times corresponding to the amount of time the student user interface unit has remained in a corresponding state; provide the one or more grade reports through the administrative interface unit; and provide the one or more grade reports through the student user interface unit.

In another aspect, the automated grading unit is further configured to track indications of progress across an aggregate of students; and wherein the grades included in the grade reports are based at least on a comparison of (i) the indications of progress across the aggregate of students and (ii) the indications of progress received through the student user interface unit for a particular student.

In another aspect, a method for administering one or more remote integrated learning environments on a system having one or more processors is provided, the method comprising: providing an administrative interface unit configured for communication with a first set of remote computing systems being utilized by one or more administrators; providing a student user interface unit configured for communication with a second set of remote computing systems being utilized by one or more students; providing an integrated learning environment unit configured to interoperate with the administrative interface unit and the student user interface unit; receiving, electronic instructions representative of learning materials from the administrative interface unit; automatically parsing the electronic instructions to extract a plurality of steps to be performed by the one or more students, each step of the plurality of steps having linkages to at least one other step, the linkages indicating progression between the steps of the plurality of steps, the electronic instructions including at least graphical information to be displayed through the student user interface unit for each step of the plurality of steps; automatically provisioning, to the student user interface unit, one or more remote integrated learning environments having at least the plurality of steps, the one or more remote integrated learning environments provided for use by the one or more students through the student user interface unit, each of the plurality of steps triggering the provisioning of a corresponding state by the student user interface unit; tracking, using a timer, one or more elapsed times, each of the elapsed times corresponding to an amount of time the student user interface unit has remained in a corresponding state; based on the linkages between the steps of the plurality of steps, switching between the steps of the plurality of steps when sufficient indications of progress are received through the student user interface unit, triggering changes of state by the student user interface unit; providing a series of visual indicators, each of the visual indicators indicative of each step of the plurality of steps; providing, in a first format, a visual indicator of the series of visual indicators associated with a current step being provided by the student user interface unit; and providing, in a second format, visual indicators of the series of visual indicators associated with steps already traversed by the student user interface unit.

In another aspect, the system further includes a transaction unit, the transaction unit configured for performing steps of: receiving one or more requests to provision one or more selected remote integrated learning environments from the student user interface unit, each of the one or more selected remote integrated learning environments having a number of available positions; determining whether there is availability in the one or more selected remote integrated learning environments by determining whether any of the one or more selected remote integrated learning environments has the number of available positions greater than 0; if the number of available positions greater is than 0 for the one or more selected remote integrated learning environments, receive an indication of payment from the student user interface unit; causing the provisioning of the selected one or more selected remote integrated learning environments having the number of available positions greater than 0 through the student user interface unit; generating one or more activation codes, each of the one or more activation codes being adapted to control access to the selected one or more remote integrated learning environments being provisioned; decrementing the number of available positions for each of the one or more provisioned remote integrated learning environments by one; causing a first electronic payment to be provided to a service provider, the first electronic payment transferring funds corresponding to a first portion of the received payment; and causing a second electronic payment to be provided to a content provider, the second electronic payment transferring funds corresponding to a second portion of the received payment.

In another aspect, the method includes receiving, from the second set of remote computing systems being utilized by the one or more students, one or more sets of textual information, each set of textual information associated with a corresponding step, and wherein the system further includes a report creation unit configured for automatically generating a textual report collating the one or more sets of textual information, the one or more sets organized by step.

In another aspect, the linkages provide a non-linear progression through the plurality of steps.

In another aspect, the student user interface unit is configured to provide just-in-time help through the student user interface unit.

In another aspect, the just-in-time help is provided when the student user interface unit receives a request for help.

In another aspect, the just-in-time help is provided through the administrative interface unit.

In another aspect, the just-in-time help is provided when the student user interface unit determines that the student user interface unit has remained in a state beyond a pre-defined threshold of time.

In another aspect, the automated grading unit is further configured to perform steps including: tracking indications of progress across an aggregate of students; and wherein the grades included in the grade reports are based at least on a comparison of (i) the indications of progress across the aggregate of students and (ii) the indications of progress received through the student user interface unit for a particular student.

In some aspects, a system including one or more modules for content authoring/creation; implementing a student experience; performing lab management & analytics; and supporting a content marketplace is provided. Corresponding methods and computer-readable media are also provided.

In some aspects, a system is provided including an algorithm/process by which an existing document will be analyzed, processed, broken down and converted into the system.

In some aspects, the system utilizing an algorithm/process wherein document content is organized into objects within steps in a structure, and specifically, having functionality to reorder, reorganize, and rebuild a piece of lab course by manipulating information from high level objects, low level WYSIWG (what-you-see-is-what-you-get) editors and/or word processing environments.

In some aspects, the system wherein the modules may be configured to provide interactive learning steps whose steps may be organized, steps having content that can be created and/or associated within them, and the order and types of object within each step can be manipulated.

In some aspects, the system may be configured to provide functionality to save, on a periodic basis, action and edits.

In some aspects, the system may be configured to provide functionality to preview how an interface may appear to an end user.

In some aspects, the system may be configured to provide functionality for previewing and navigating through thumbnail lab steps that displays a summary of the step, status of any actions/deliverables within a step, a preview of content, as well as which steps have been completed and which have not.

In some aspects, the system may be configured to provide functionality for providing additional student help during the implementation of an interactive learning experience.

In some aspects, the system may be further configured to provide the ability to access supplemental resources directly within a specific lab step/direction, that is relevant to the concept being learned.

In some aspects, the system may be configured to provide a just-in-time help window that can be set up for conditional release based on the student progress throughout the lab and answers to evaluation/assessment questions during the lab, or that can be triggered manually by the lab instructor, or be setup to trigger/become available after a predefined time.

In some aspects, the system may be configured to provide support for additional types of triggers (manual/automatic/combination) set by the content author.

In some aspects, the system may be configured to provide functionality for the creation of reports by leveraging and reusing the work completed as part of the interactive learning.

In some aspects, the system may be further configured to provide access to any/all student responses to questions within the lab, and any/all notes taken by the student and group members.

In some aspects, the system may be configured to enable authors to define a template for reporting when creating a lab which would automatically prefill the report based on student notes/answers.

In some aspects, the system may be configured to utilize an algorithm and method to convert a report to standard document format for storage and submission through traditional means.

In some aspects, the system may be configured to enable an instructor to edit content that is currently being used by students in a lab (for example, in case there is a mistake, or edit, or update that needs to occur) and to automatically push an update to the content to one or more student users who are accessing that piece of content, updating content in the background.

In some aspects, the system may be configured to enable an instructor to create content and to push the content out to client applications based on lab attendance, groups selections, course, etc.

In some aspects, the pushed content can contain assessment questions, HTML content, video, images, etc., and the pushed content may be overlaid over other content is on the client device.

In some aspects, the system may be configured such that the client/user must acknowledge the pushed content before proceeding with the rest of their lab.

In some aspects, the system may be configured for enabling an instructor to evaluate submitted reports, automatically and/or manually.

In some aspects, the system may be configured to sort, filter and pivot information by student or by question.

In some aspects, in the case of automatic marking, an instructor would be able to validate the automatic marking, and in the case of manual marking, can assign full or partial marks.

In some aspects, the system may be configured to display the marking rubric for each question while engaging in marking.

In some aspects, the system may be configured to enable users to share notes, images, videos, observations, results and any other activities and assets, within groups or with individual users.

In some aspects, the system may be configured to enable instructors to view and determine the amount of original and copied content in a user's account.

In some aspects, the system may be configured to enable users to see a complete history of their actions.

In some aspects, the system may be configured to utilize data collected throughout the interactive learning session to perform quantitative assessment of group participation.

In some aspects, the system may be configured for automatically evaluating each group member based on the data available, and various weighted metrics may be utilized.

In some aspects, the system may be configured to evaluate group activities and assets side-by-side.

In some aspects, the system may be configured providing various reports and views for an administrator to obtain a high level view of all activities in the interactive learning session.

In some aspects, the system may be configured for the distribution, selling, and/or sharing of various documents, learning sessions, information and/or workflows created within the system.

In some aspects, the system may be configured for setting pricing and/or royalties based upon different types of users and/or groups.

In some aspects, the system may be configured for determining and/or holding back a portion of sales to be provided to the providers of the system.

In this respect, before explaining at least one embodiment in detail, it is to be understood that embodiments are not limited in its application to the details of construction and to the arrangements of the components set forth in the following description or illustrated in the drawings. Other embodiments are capable of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments are illustrated by way of example. It is to be expressly understood that the description and drawings are only for the purpose of illustration and as an aid to understanding.

Embodiments will now be described, by way of example only, with reference to the attached figures, wherein:

FIG. 1 is a sample system architecture diagram, according to some embodiments.

FIG. 2 is a sample system architecture diagram illustrating example units that may be used to implement some embodiments.

FIG. 3 is an annotated sample layout for the content authoring/creation tool indicating steps of importing a lab from a document or creating one using the tool, according to some embodiments.

FIG. 4 is an annotated sample layout for the content authoring/creation tool where a user may be able to input and/or reorder various objects/steps, according to some embodiments.

FIG. 5 is an annotated sample layout of a screen of the student experience application, according to some embodiments.

FIG. 6 is an annotated sample layout of a screen providing information and assessment for a step, as well as ‘just in time help’, according to some embodiments.

FIG. 7 is an annotated sample layout of a screen providing automated report creation, according to some embodiments.

FIG. 8 is an annotated sample layout depicting lab manager capabilities, wherein an instructor could edit existing content and/or push the content to client applications based on lab attendance, group selections, course, etc., according to some embodiments.

FIG. 9 is an annotated sample layout depicting a push of quiz material to the student application tool, according to some embodiments.

FIG. 10 is an annotated sample layout for marking within a lab manager module, according to some embodiments.

FIG. 11A is an annotated sample dashboard, according to some embodiments.

FIGS. 11B, 11C, 11D, 11E, 11E, 11F, 11G, and 11H are sample dashboard screenshots, according to some embodiments.

FIG. 12 is a sample sales portal hierarchy, according to some embodiments.

FIG. 13 is a sample institution login page, according to some embodiments.

FIG. 14 is a workflow illustrating sample steps in provisioning a learning environment, according to some embodiments.

FIG. 15 is a detailed workflow illustrating sample steps in provisioning a learning environment, according to some embodiments.

FIG. 16 is a workflow illustrating sample steps in provisioning a learning environment, according to some embodiments.

FIG. 17 is a workflow illustrating sample steps in provisioning a learning environment, according to some embodiments.

FIG. 18 is an illustrative diagram providing computer hardware and software implementation of certain aspects, as detailed in the description.

### DETAILED DESCRIPTION

Methods, systems, and apparatus suitable for use in implementing some embodiments are described through reference to the drawings.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The present description may describe various embodiments of systems, methods and/or computer program products related to learning management systems.

In traditional settings, content may often be disseminated for lectures, using a “sage on the stage” approach, and existing tools may be adequate to determine that students may be accessing the materials and staying on track for the coursework.

However, the existing model may not be sufficient to support learning environments that contain experiential learning, such as, for example, learning techniques employed in science, technology, engineering, and mathematics (STEM) education (e.g., laboratory style learning experiences).

Often, learning may be a discovery-based learning method, which may include progression through concrete steps, collaboration with group members and instructors, real world linkages, and/or the ability for students to try-and-fail and then succeed through guidance/additional help.

In these situations, simply providing a static document may be suboptimal in supporting both students and educators during experiential learning, especially within laboratory-style learning environments. Students may often be frequently distracted and lost, and their learning may include assistance from other students, teaching assistants and/or instructors.

Some challenges faced by using conventional LMS may include students not being able to effectively share notes or interact with other students/educators, and/or educators having limited insight as to how students are progressing beyond what educators determine from formally submitted reports.

A new, improved and/or different solution is thus needed for overcoming the shortfalls of the solutions currently available in the market.

The systems, methods and/or computer program products of embodiments of the present disclosure may be directed towards a set of tools integrating various electronic technologies for delivering experiential learning.

Experiential learning may be various types of interactive learning, such as, for example, laboratory experiments. Experiential learning may often be utilized at various levels of education, especially those in STEM disciplines (Science, Technology, Engineering, Math).

The users may include content creators/authors, administrators, educators, and/or content consumers. These groupings may not be exclusive and a user may be a member of various groups. The users may also be associated through various hierarchies. For example, an educator may author content, which may be consumed by students. Educators may include, for example, professors, lecturers, teachers, teaching assistants, etc. Administrators may, for example, be able to invite users to a particular platform, modify aspects of how laboratory sessions are run, change step progression criteria, set user roles, etc.

The tools may provide functionality enabling authors to develop content, which may then be consumed by content consumers based upon various pre-defined workflows. The tools may provide functionality for the authoring/creation of various types of content, such as multi-media rich and/or dynamic content. Learning environments include integrated learning environments, where users may interact with various devices, each other, perform various tasks and/or activities in relation to a particular set of activities. These activities may be grouped logically into various steps, and the steps may be linear, non-linear, conditional, dependent, independent, etc. In an embodiment, progression may be tracked and/or caused by the satisfaction of various conditions for progression, and progression through steps may be different depending, for example, on aspects of the conditions for progression, etc. For example, a student obtaining a high grade for a particular step may be progressed through to a first step, while a student obtaining an average grade for the step may be progressed to a second step, the second step being designed as a step prior to eventually progressing through to the first step. In this example, the second step may be a step applied to help solidify the teachings of a particular concept.

Accordingly, in some embodiments, the tools may be configured for automatic, intelligent progression through a series of steps, wherein students are progressed through the system at varying rates and/or steps based on student performance, among other variables.

This may offer a flexible learning platform that may be difficult, cumbersome, and/or impossible to reproduce in a non-electronic learning environment. For example, there may be timers used to track elapsed times, interfaces with learning devices (e.g., an oscilloscope, a computer for running various programs), etc. that may track aspects related to progression through steps. These may interoperate with one another to aid in guiding students at a pace that is more well suited for their particular needs. Further, there may be grading/reporting aspects which take into consideration the automatic progression and/or tracked and/or monitored information in conducting automated grading and/or report generation.

For example, in a laboratory environment, such as a control systems pendulum balancing experiment, a student may be required to access the steps in a sequential order, and keep track of progress as the student learns how to effectively balance the pendulum using a proportional-integral-differential controller. There may be one or more steps involved in the process, various milestones to be achieved, various work products to be submitted and/or various collaboration opportunities. In some embodiments, a student may not be permitted to move to a further step until a prerequisite step is achieved satisfactorily. In some embodiments, additional steps may arise to reduce the difficulty level of the lab or to provide intermediate steps.

Users may also utilize the tools to collaborate with one another, for example, supporting interactions between educators and other educators, educators and students, students and students, etc.

Further, the users may conduct various analyses based on data collected by the tools; conduct administrative tasks, such as setting out lab workflows, marking various work products, etc. For example, the tools may be configured to provide instructors the ability to manage a lab environment, including detailed analytics on performance, and/or functionality designed to help maintain/measure student focus. In some embodiments, instructors may be able to view and/or set up alerts when the system determines that students may not be focused on lab materials or having problems learning (e.g., students are all spending large amounts of time on step C, many questions are being asked about how to perform a step, many unsatisfactory results occur due to apparatus contamination).

In various embodiments, a set of tools may be described, such as:
a content authoring/creation tool;
a student experience tool;
a lab management & analytics tool; and
a content marketplace.

These tools may be provided in various embodiments, and it is to be understood that this listing of tools may not be exclusive, and there may be more, less, and/or different tools provided.

These tools may be supported by various backend systems, and may also be provided on a number of electronic devices, which may include specially configured machines and/or systems.

The tools and/or backend systems may be configured for communication with one or more external systems, and/or one or more external apparatuses, such as laboratory testing equipment, oscilloscopes, etc. For example, the tools may be configured for communication to receive lab results directly from an apparatus such as an oscilloscope, etc.

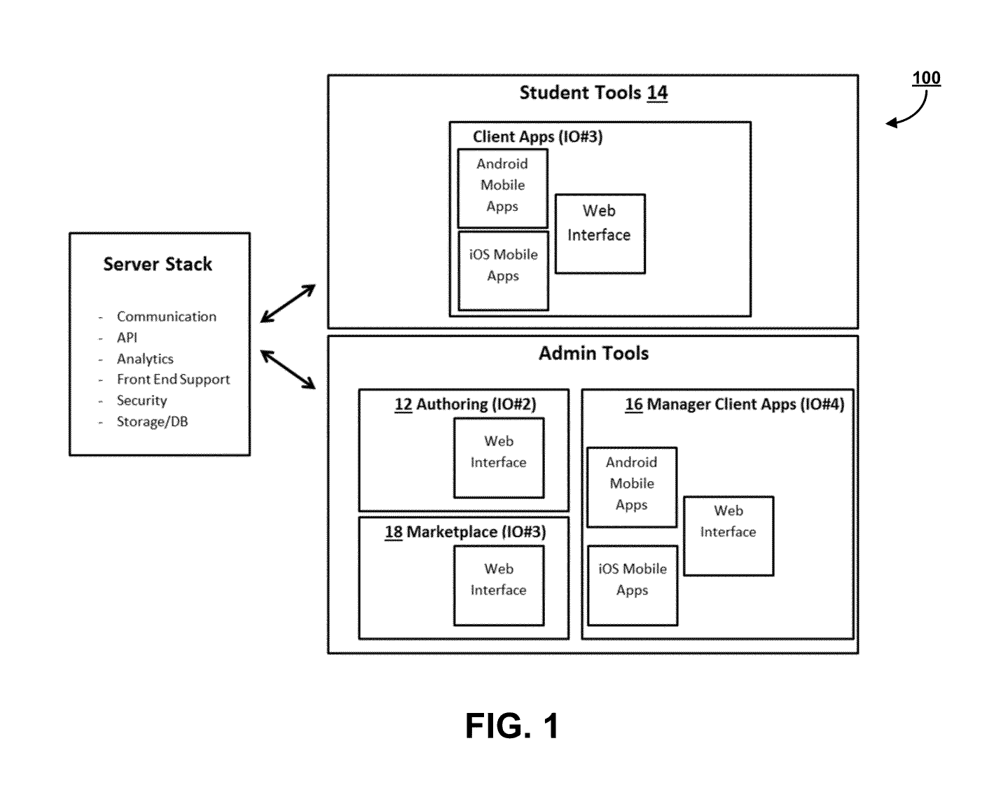

FIG. 1 is a sample system architecture diagram, according to some embodiments. Components may include the backend systems, labeled the server stack, which may include various modules for communication, application programming interfaces (APIs), analytics, front-end support, security, and/or storage.

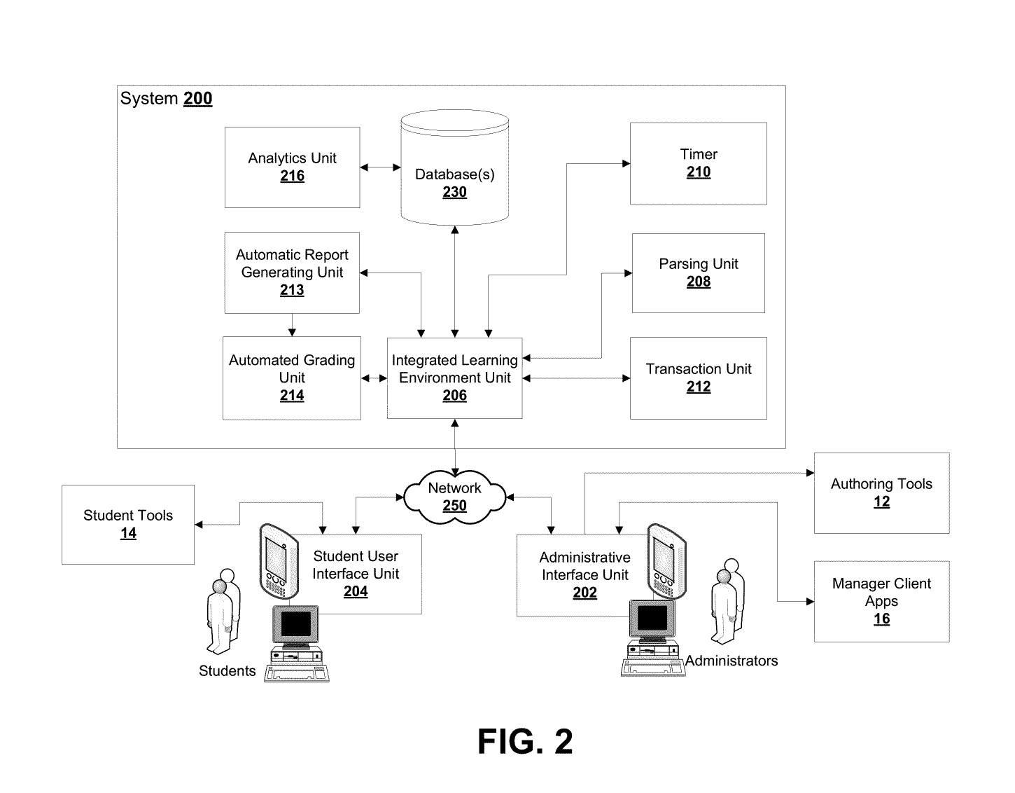

FIG. 2 is a sample system architecture diagram illustrating example units that may be used to implement some embodiments.

These components may support various student tools, which may include for example, Android™ mobile applications, iOS™ mobile applications and/or web interfaces. Other types of mobile and/or device interfaces may be considered.

These components may support various administrative tools, which may include, for example, an authoring tool, a marketplace tool, a manager for client applications, etc. These various administrative tools may be associated with various mobile applications and/or interfaces. For example, these may include Android mobile applications, iOS mobile applications and/or web interfaces.

Offline and/or online access may be contemplated for use with the various components, for example, enabling the ability to work offline where there is poor connectivity. The components may be configured to synchronize with a backend to pull down latest labs; upload results and activities, such may also be configured to run independently from the backend.

The hardware supporting these components may be comprised of one or more servers having one or more processors, operating in conjunction with one or more computer-readable storage media, configured to provide backend services, such as data processing, data storage, data backup, data hosting, among others.

The various devices, such as mobile electronic devices, may include further sensors such as proximity sensors, gyroscopes, near-field communications sensors, ambient light sensors, force sensors, location sensors, cameras, radio-frequency identification sensors, humidity sensors, temperature sensors, capacitive sensors, resistive sensors, and surface acoustic wave sensors, among others. The sensors may be of various models, makes and functionalities. For example, the sensors may vary in model, specifications and in quantity between generations and particular brands.

Various functionality on mobile devices may also be accessed to provide notifications, for example: indicating when a lab is available; when a lab is almost due; lab instructions, any updates that arise; when chat messages are received; when a report is marked; when a poll or question is pushed by an educator, etc.

Interfaces between systems may be comprised of an application programming interface (API) that provides a communications means between various machines. An API may be implemented via various technologies, such as Simple Object Access Protocol (SOAP), interfaces developing through exposing functionality using programming code, representational state transfer (REST adhering programming techniques), etc.

Other protocols for integration may also be utilized, such as Sharable Content Object Reference Model (SCORM), a collection of standards and specifications for web-based e-learning; and experience API (xAPI). There may be LMS integration with other types of systems, and/or the generation of http interfaces/permalinks, integration with content marketplaces (e.g., application stores such as iTunes™ or Google Play™)

Storage may be implemented using various database technologies, such as relational databases (e.g., SQL databases), flat databases, excel spreadsheets, comma separated values, etc. If the storage is implemented using relational database technology, the storage may be configured to further store relationships between various data records. The storage may be implemented using various hardware of software technologies, such as solid state or hard disk drives, redundant arrays of independent disks, cloud storage, virtual storage devices, etc.

The system may be configured for operation over one or more networks. The one or more networks may include the internet, intranets, point to point networks, etc. Networking technology may include technologies such as TCP/IP, UDP, WAP, etc.

Communications between one or more devices may be implemented via a multitude of current and legacy connection protocols including Bluetooth, Bluetooth low energy, USB, serial, infrared, NFC, WiFi, ANT+, etc. The interface, in some embodiments, may also be implemented using appropriate application programing interfaces (APIs).

In some embodiments , the backend systems may be implemented through a set of distributed computing devices connected through a communications network. An example of such a set of distributed computing devices would be what is typically known as a ‘cloud computing’ implementation. In such a network, a plurality of connected devices operate together to provide services through the use of their shared resources.

In some embodiments, the system may be configured such that the student tools (for consumption and completion of labs) may be configured for connection to instructor/management tools through one or more intermediary servers. In some embodiments, behaviours within the tools, by various users, may be captured locally on the client apps, and may be communicated to a centralized server.

### Content Authoring/Creation Tool

The content authoring/creation tool 12 may be implemented through one or more modules, which may be configured to convert experiential learning into various workflows. The modules may be implemented in either software or hardware, or both. For example, the modules may be implemented through machine/computer-readable instructions on a processor.

In some embodiments, the student experience application may be implemented through cloud-computing techniques and systems.

The workflows may have various characteristics associated with them, as well as logical rules dictating the operation of the workflows. For example, a lab may include various step-by-step procedures that may further include assessment across sections and instructors at various steps.

For example, a content authoring/creation tool 12 may provide a web-based interface, where an author can create new lab or modify from an existing lab as starting point.

The content authoring/creation tool 12 may be configured to permit users to import documents (e.g., Microsoft Word, Microsoft Excel, or Adobe PDF documents, comma-separated values (CSV), extensible markup language (XML), hypertext markup language (HTML) or simply scans of physical documents) directly into the tool, and/or create lab workflows using the tool.

In some embodiments, a combination of the two methods can be utilized, wherein content may be imported and logic be applied to develop lab workflows.

In further embodiments, the importing of documents directly into the tool may cause the system to extract various information from the documents, such as document contents, document metadata, etc. For example, an algorithm may be utilized to process the document, break it down into key components/steps, and/or translate it into a format suitable for use with the content authoring/creation tool.

Workflow logic may be applied through defining and/or applying one or more rule sets and/or data structures. For example, rule sets may be generated to indicate that step 1 must be done before step 2, there is an assessment at step 3, that a student may be able to skip step 5 altogether as step 5 is optional, etc. The rule sets may also be generated to cause various behaviors, such as the selective release of lab by date, the selective release of steps, various inline assessments, etc.

Where a document is uploaded, the system may be configured to automatically extract various information and take actions accordingly, such as: detecting steps, automatically upload and link: images, equations, hyperlinks, section headings, tables and formatting, etc.

The rules may be configured to provide flexibility and/or automation in how authors chose to implement interactive learning, and may also include logic designed to provide support for learning administrators, such as teaching assistants. For example, various triggers could be created, with logic being applied when a monitored trigger is triggered, etc. Triggers may include monitored information, such as a student requesting help on a step, taking too long on a step, spending too little time on a step, etc.

The content authoring/creation tool 12 may be configured to create one or more lab groupings, which may be a set of labs grouped for a particular topic (e.g., LLC resonant tank circuit labs), or groups based on users (e.g., the mechanical engineering group), etc.

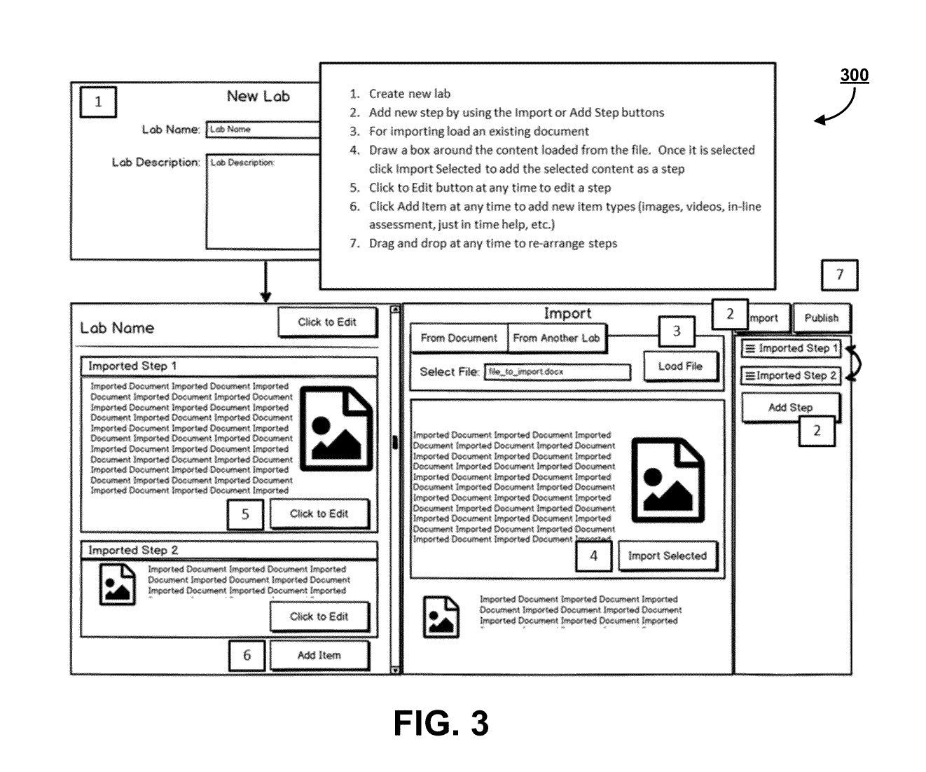

FIG. 3 is an annotated sample layout for the content authoring/creation tool 12 indicating steps of importing a lab from a document or creating one using the tool, according to some embodiments. The annotations on the figure are example steps provided to aid in understanding.

As indicated in FIG. 3, the content authoring/creation tool 12 may be configured to allow an author provide a lab name, a lab description, and may be able to decide whether to import a lab from an existing file, or creating one using the tool.

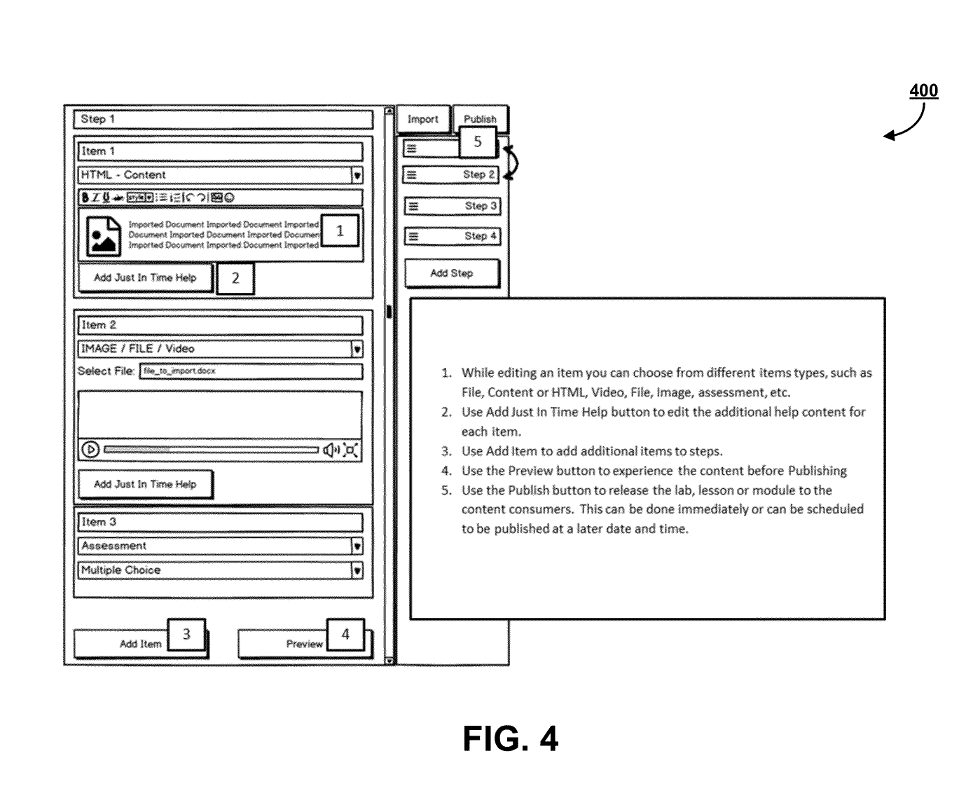

FIG. 4 is an annotated sample layout for the content authoring/creation tool 12 where a user may be able to input and/or reorder various objects/steps, according to some embodiments. The annotations on the figure are example steps provided to aid in understanding.

The content authoring/creation tool 12 may be configured such that various items can be generated, with help for students optionally associated, and content may be provided in various formats, such as rich text and/or multimedia-enabled formats. A user may be able to manipulate the order and types of object within each step, and in some embodiments, user actions and edits may be saved periodically on a local device, providing backup functionality.

The content authoring/creation tool 12 may also provide administrators the ability to preview what the learning experience would be displayed and/or interacted with from the perspective of a content consumer, such as a student. Further, the content authoring/creation tool 12 may be configured to provide just-in-time help functionality, whereby students may be able to request help from an administrator and/or other students who may have completed the step successfully. For example, help may be provided in the form of hints, messages, telephone calls, requesting in person guidance, video conferencing, etc.

The Student Experience Application

The student experience application may be implemented through one or more modules, which may be configured to provide access to authored content (e.g., labs) as well as provide relevant, timely support and centralized documentation and communication. The modules may be implemented in either software or hardware, or both. For example, the modules may be implemented through machine/computer-readable instructions on a processor. In some embodiments, the student experience application 14 may be implemented through cloud-computing techniques and systems.

The student experience application 14 may be configured to support various workflow logic as defined by various rule sets by the author of the content. For example, the rule sets may be applied to ensure that a student conducts a lab through a particular order of steps, to indicate that a step may be option, to indicate that a step is a pre-requisite for another step, to require the student to submit formal documentation at various steps, require the student to obtain an assessment at a particular step, etc. Rule sets and/or triggers may also be monitored by the student experience application 14.

The student experience application 14 may also be configured to capture work products using multimedia tools (e.g., audio, video, pictorial, photographical, outputs from various external sources) and to aggregate work products for submission in a report. For example, a student may be able to submit a photograph of a working apparatus, a video of a device in motion and/or code indicating successful completion of a software module.

For various types of devices, the student experience application 14 may be configured to operate with devices having various shapes, sizes and dimensions, and the content may be rendered appropriately, involving, for example, the management of the width of windows, font sizes, graphic scaling, scrolling, formatting of tables, pictures, other objects, the use of new windows for some content, providing gesture functionality such as pinch-to-zoom and swiping. A consistent experience may be provided across devices.

The student experience application 14 may also be configured to permit students with the ability to register, associate with their accounts various information, access the information based on their credentials, and authenticate these credentials. The accounts may also be grouped and/or linked at an institutional level. The groups, in some embodiments, may contain the ability to randomly select and/or generate groups, or to develop groups based on various logic and/or criteria as set out by an administrator (e.g., groups of a particular distribution).

In some embodiments, the student account may be tied to various external systems, such as their registration within a learning institution (e.g., a University's records and/or existing LMS), their social media accounts (e.g., Twitter™, Facebook™, Google+™)

In some embodiments, the student experience application 14 may be configured such that a student may be able to view what material has been made available to him/her, such as a list of current and previous lab courses, that can be sorted and filtered, and/or access to his/her own notes, assessments, etc. Such access may be provided, for example, through a dashboard view of labs, which may include information such as, but not limited to: short descriptions, marks for submitted labs, % complete of in-progress labs, lab-specific tasks and reminders. Such functionality may be potentially useful to easily and conveniently permit a student to see what actions need to be taken.

In some embodiments, the student experience application 14 may be configured to support various functionality associated with a student's mobile device, such as input gestures, multimedia functions, and other types of inputs (e.g., audio, camera). For example, the student experience application 14 may be configured to support tap, hold and swipe functionality, which when provided on a step thumbnail, will show a popup of a short description of a step, along with other types of associated information. Previews may provide access to summary views of future steps, which may be useful for a student to determine which course of action to take and to estimate how much progress can be made within a given period of time. Further, a student may feel in control of the interactive learning process as it may be easier to identify various steps, identify his/her own progress and to derive elements of information in a convenient manner.

In some embodiments, the student experience application 14 may be configured to provide a view of a user's actions, though, for example, a timeline. The timeline may also be used to see what is being collected for instructor view/review, and his/her assessments. Various actions may be shown, such as navigating between steps, opening help, any data entry to inline assessment fields, photo notes, video notes sound notes, text notes, etc.

The sharing of notes may be conducted at a group level, an individual level, through a timeframe (e.g., next X hours, until date/time, until end of submission deadline), and logic can be applied to indicate settings, such as default behaviour. Multimedia content may also be shared. Notes can be designed at a group level for convenient sharing, and where indicated, a user may be able to move a note authored by another into his/her own notes. In some embodiments, an instructor or administrator may be able to view the amount of original as opposed to copied content for a given user or group of users.

For example, the lab author of a lab may determine for each inline assessment field whether it is shareable or not, but students can still decide to share or not, if author has deemed a field shareable.

In interacting within a step, various functionality may be provided, such as multiple choice questions; fill in the blanks; note fields (min and max characters); drag and drop of various objects; selection boxes; requirements to take photos; recording of videos; and/or recording of sound. Note fields may be accessible and associated with a user's progress and/or account, and may also include multimedia information, such as photos, sounds, text. Notes may be indexed, searchable and/or time-stamped. Notes can be set as private or public, and may also be shared.

Where a step requires various prerequisites (e.g., assessments completed, steps completed), the student experience application 14 may indicate that a student cannot move on unless the prerequisite is met (e.g., the answer is complete and/or correct).

In further embodiments, the system may be configured such that providing one or more incorrect answers can unlock help or other steps.

In some embodiments, the student experience application 14 may provide for the manual and/or automatic grading of work products, and such grading may be binary (e.g., right or wrong, numeric with a set of tolerances), or qualitative. Assessments may also be able to provide various tables and graphical representations of information. Depending on the level of “correctness”, alternative help may also be recommended. A potential advantage to such an approach may be a reduced burden of marking for the educators, providing immediate feedback to a student and/or the ability to responsively take action (e.g., addition of an intermediate step to make a task easier).

The student experience application 14 may also be configured to provide help to a student, and the help can be provided in various ways, such as just-in-time help from an educator, help from students, hints and tips, etc. Various logical elements may be implemented to require that students may have sufficient time to learn and explore through trial and error, but also receive help when necessary. In some embodiments, help is initiated by the students, and in some embodiments, help may be initiated automatically or by the educators. Help from students may require collaboration and/or sharing of notes between students. Help may be provided in various forms, such as text messages, pictures, animations, multimedia, video conferencing, teleconferencing, a request for physical help, etc.

The student experience application 14 may also be configured to conduct reporting functions, where a user may be able to develop reports which may contain traceable data from the interactive lab experience. Functionality may be provided for the auto-population of information (e.g., based on logical rules around metadata, associated information regarding a particular step), items may be manually imported into a report from other areas of the application, etc. Such functionality may be used for assessments and/or self-assessments, for example.

Authors of lab content may pre-determine which fields may be required in an assessment or a report, and if these are inline answers/inline observations, then the reporting may be automated. The particular set of fields may be locked, or if not locked, the student can still add fields within the template. The report or assessment may also be submitted to various other users or educators, and may be marked either automatically or manually. Other information, such as traced activities during the lab, may also be submitted, and the transfer of this information may occur on a transparent basis, in some embodiments.

In further embodiments, the generation of a report may cause the generation of various formats of information, such as email, an XML file, a simple Microsoft word document and/or PDF document, wherein text and pictures may be rendered inline. Multimedia content may be provided as a hyperlink object to the file. A potential benefit may be interoperability with traditional report writing practices, and/or standard submission processes within an LMS. If the information is provided in the form of an email, it may be automatically sent by the system.

The student experience application 14 may be configured for collaboration between students and/or other users, such as educators and administrators. The collaboration may include the use of avatars, groups, sharing of documents, chatting, etc. Collaboration features may be flagged as private and/or public, and in some embodiments, transcripts may be saved as well.

In some embodiments, students and/or instructors may also interact with the student experience application 14 in real-time or near real-time, and conduct actions such as pushing out content, providing instructions, disabling various functionality, implementing various logical rule sets, implementing various workflows, modifying steps, pushing questions or polls, providing time limits, etc. The potential benefit of such functionality is the ability to cause real-time learning validation and dissemination of critical information.

There may further be search capabilities available on all screens, where users can select and filter search results between different types of documents, such as: courses, labs, steps, help, answers, notes, chat transcripts. Further, users may be able to filter on various elements, such as active and completed labs.

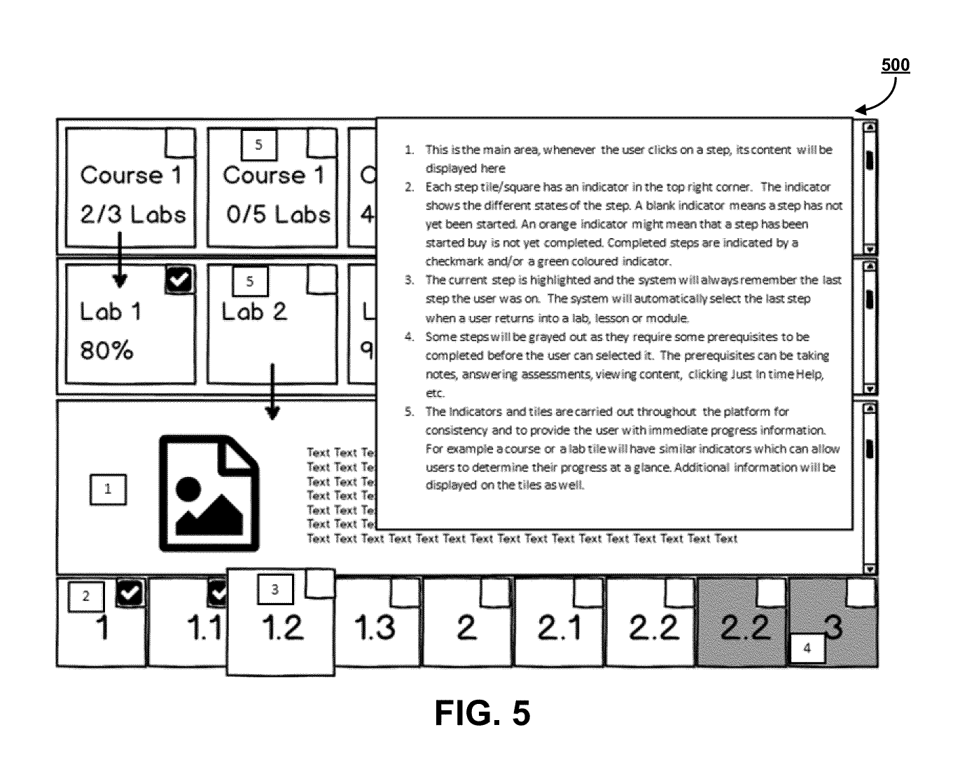

FIG. 5 is an annotated sample layout of a screen of the student experience application 12, according to some embodiments. The annotations on the figure are example steps provided to aid in understanding.

As indicated in FIG. 5, there may be a progress bar that may be updated in line with progression through a series of steps, and the steps may also be grouped into logical sets and/or hierarchies, such as 1.0, 1.1, 1.2 for the first set of steps related to one experiment, 2.0, 2.2, 2.2, 2.3 for the second step of steps related to a second experiment, etc. Completed steps may be indicated by checkmarks or any other type of marking (e.g., a green circle). Students may be able to navigate between steps, visit steps that have already been completed (especially where the outputs of a step are inputs into another step), and preview future steps.

Further, the student experience application 14 may be configured such that when a student selects or is otherwise viewing a step (e.g., mouse hover), the student experience application 14 may provide a summary view of the step, its status, and/or a preview of the step (if an image or video is available).

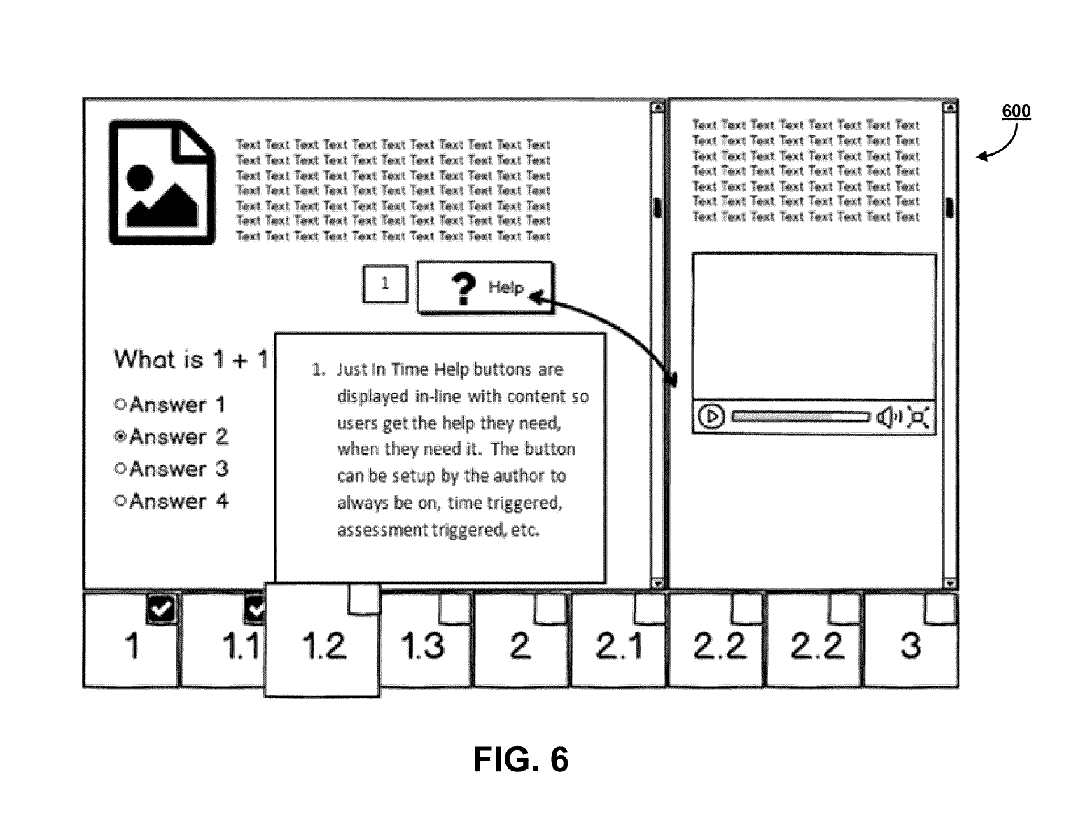

FIG. 6 is an annotated sample layout of a screen providing information and assessment for a step, as well as ‘just in time help’, according to some embodiments. The annotations on the figure are example steps provided to aid in understanding.

In some embodiments, the help window can be set up for conditional release based upon student progress throughout the lab and answers to evaluation/assessment questions during the lab, or can be triggered manually by the lab instructor, or set to trigger/become available after a predefined time to allow students to explore on their own.

A potential benefit may be providing help when it makes sense to do so in the learning environment. The system may be configured to support additional types of triggers (manual/automatic/combination) and may be set by the content author.

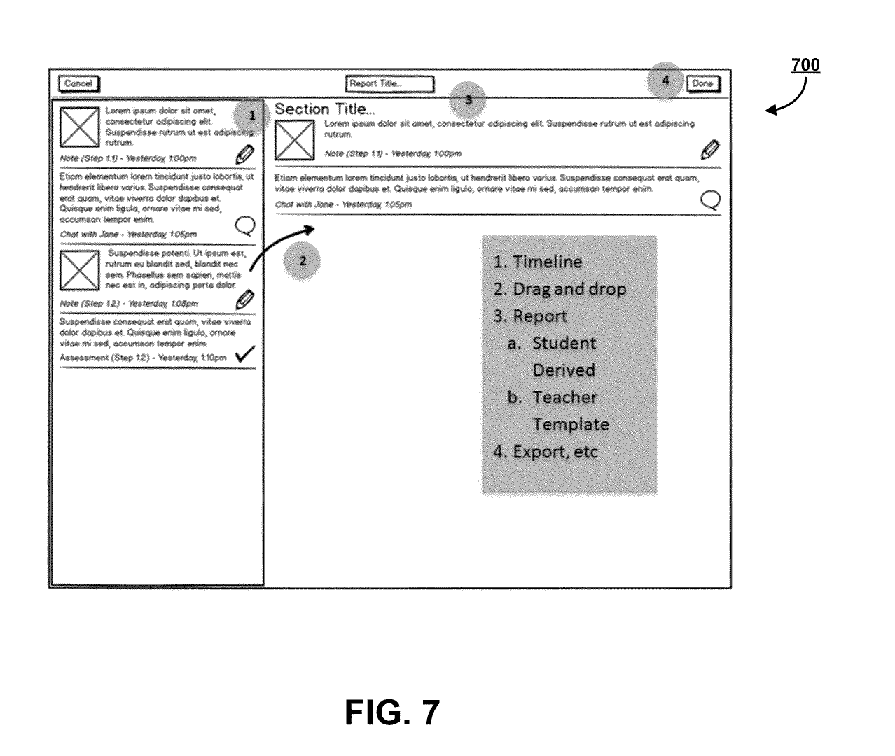

FIG. 7 is an annotated sample layout of a screen providing automated report creation, according to some embodiments. The annotations on the figure are example steps provided to aid in understanding.

As indicated by the rounded, numbered bubbles, a student may have various functionality available to generate reports based on pre-existing information in an automated, or semi-automated fashion, but also to manual lay out the report elements and/or add content. The fields may be pre-determined by an author and/or set out by a student.

### Lab Management & Analytics

A system may include one or more modules configured for lab management and/or analytics. The modules may be implemented in either software or hardware, or both. For example, the modules may be implemented through machine/computer-readable instructions on a processor. In some embodiments, the lab management and/or analytics modules may be implemented through cloud-computing techniques and systems.

The lab management and/or analytics modules 16 may be configured to monitor and/or track progress, as well as other information captured by the system. This aggregate information may be utilized by the lab management and/or analytics modules 16 to run various reports, conduct statistical analysis, etc., such as the generation of one or more assessment “snapshots” whereby an administrator may be able to conveniently view the progress of the group. These assessment “snapshots” may provide near-instant functionality to administrators wishing to view the progress of the group at a glance.

The lab management and/or analytics modules 16 may be configured to have various types of interfaces, such as a web interface, where student and professor data can be viewed, according to a hierarchy. For example, an administrator may be able to track the actions of teaching assistants (giving help, marking assessments), and/or the effectiveness of various learning modules and/or workflows.

Such functionality may be useful for real-time or near-real time reporting, the ability to track historical progress, the ability to set baseline progress (e.g., the average class completes this step in 35 minutes), highlight areas of weakness (e.g., the long time associated with this step may indicate that greater emphasis is needed on fundamentals of electrical engineering), etc.

In the context of an interactive lab environment, an administrator could use this information to tweak the lab during the running of the lab, or be alerted when there may be a serious problem in the running of the lab (e.g., step 7 does not connect to step 9 and students cannot progress any further).

In some embodiments, the lab management and/or analytics modules 16 may also be configured to support the validation of learning on macro-scales (by class, by lab) and micro-scales (student/group level) to evaluate individual progress, group contribution, and overall class success using micro-analytics (students viewing timelines, groups of students viewing timelines). For example, various learning outcomes can be measured at both the individual level and group level, and these may be indirectly measured through time to completion, # submitted, % complete, % results on questions, total time per step, activity per step, etc., and/or directly measured through assessments and achievements of students.

The lab management and/or analytics modules 16 may be configured to conduct automated lab marking, semi-automated lab marking, manual lab marking, exporting various information in various formats for use in other programs (e.g., PDFs, Microsoft Excel files), assigning qualitative and quantitative marks, etc.

Further, the lab management and/or analytics modules 16 may also be configured provide the ability to view, at a real-time or near-real time perspective, the activities of students, such as who is online at a given time, viewing information from a particular student, viewing chat client activity, accessing student questions, receiving notifications when questions are answered, etc.

In some embodiments, reports may also be generated regarding teaching assistants, indicating actions taken, upcoming and/or required actions, marking activity, chatting, mark assignment, mark distribution, etc. Such functionality may be useful for increasing accountability, determining performance (e.g., time spent marking), traceability, and providing record for the defense of complaints.

Other types of analysis may also be contemplated and supported, such as the ability to determine where students have had usability issues with the material (e.g., students have not been completing step 4 sufficiently, and upon further analysis, it appears that a figure has not been reproduced clearly and is causing confusion).

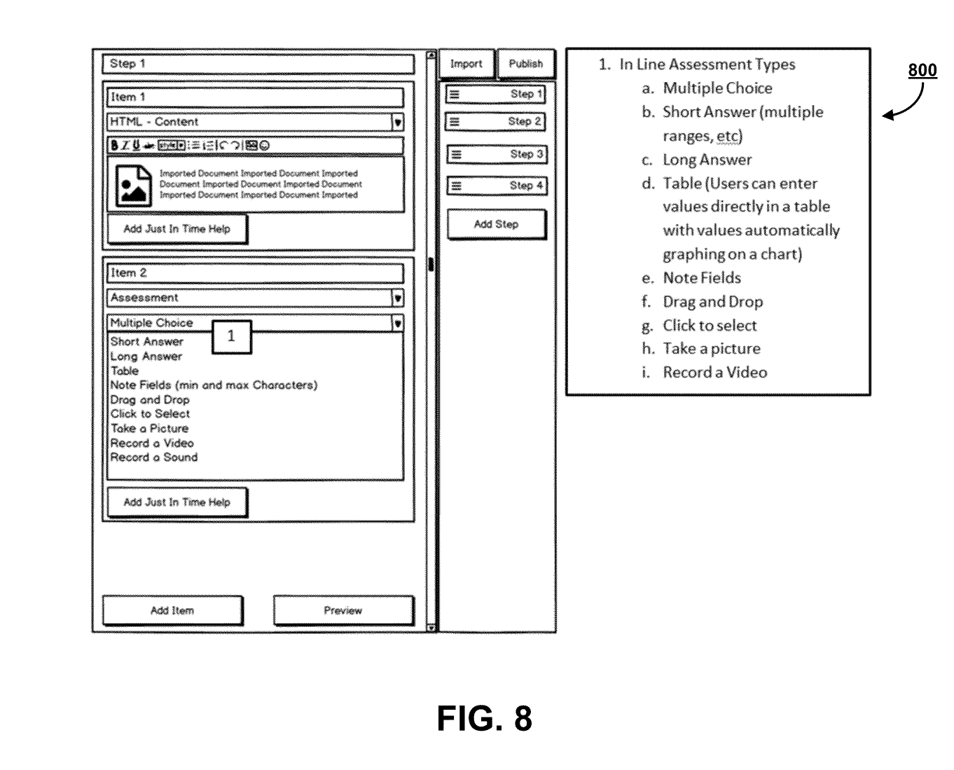

FIG. 8 is an annotated sample layout depicting lab manager capabilities, wherein an instructor could edit existing content and/or push the content to client applications based on lab attendance, group selections, course, etc., according to some embodiments. The annotations on the figure are example steps provided to aid in understanding.

For example, the content may contain assessment questions, HTML content, video, images, etc., and overlay with information is on the client device. The system may be configured to indicate that the student must acknowledge the content before proceeding with the rest of their lab. Such functionality may be useful for creating an interactive experience or correcting errors that may be found in the lab materials.

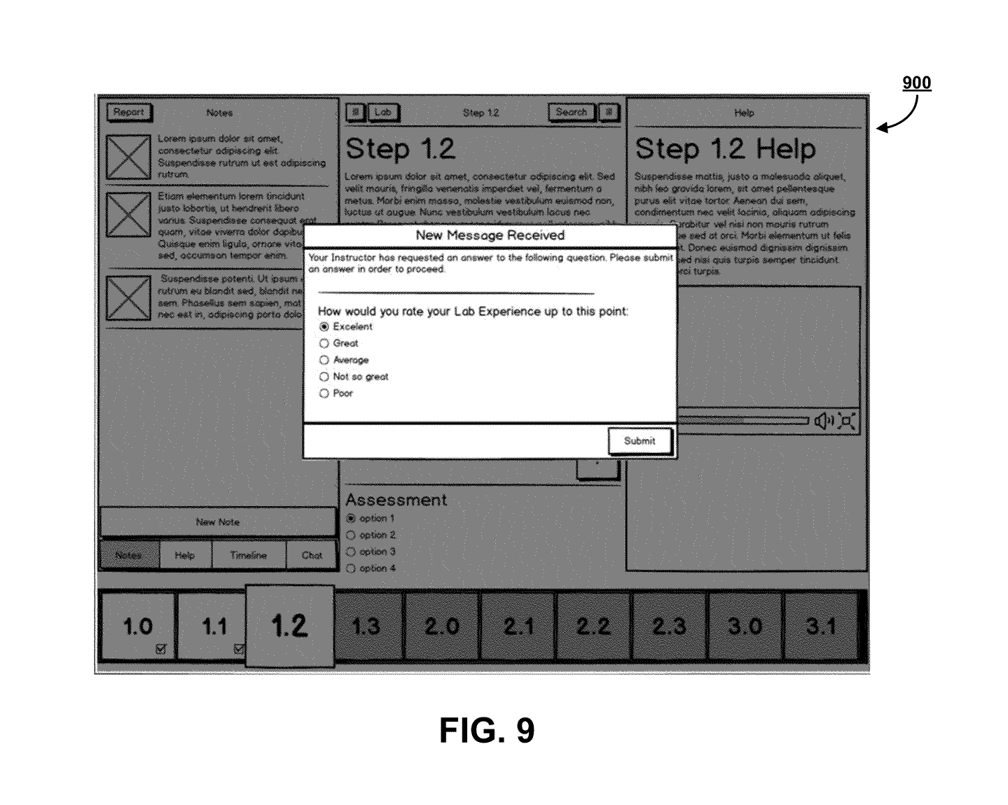

FIG. 9 is an annotated sample layout depicting a push of quiz material to the student application tool, according to some embodiments. The annotations on the figure are example steps provided to aid in understanding.

In this figure, a quiz message to rate the lab experience may be provided and a response may be provided through the selection of a pre-defined answer.

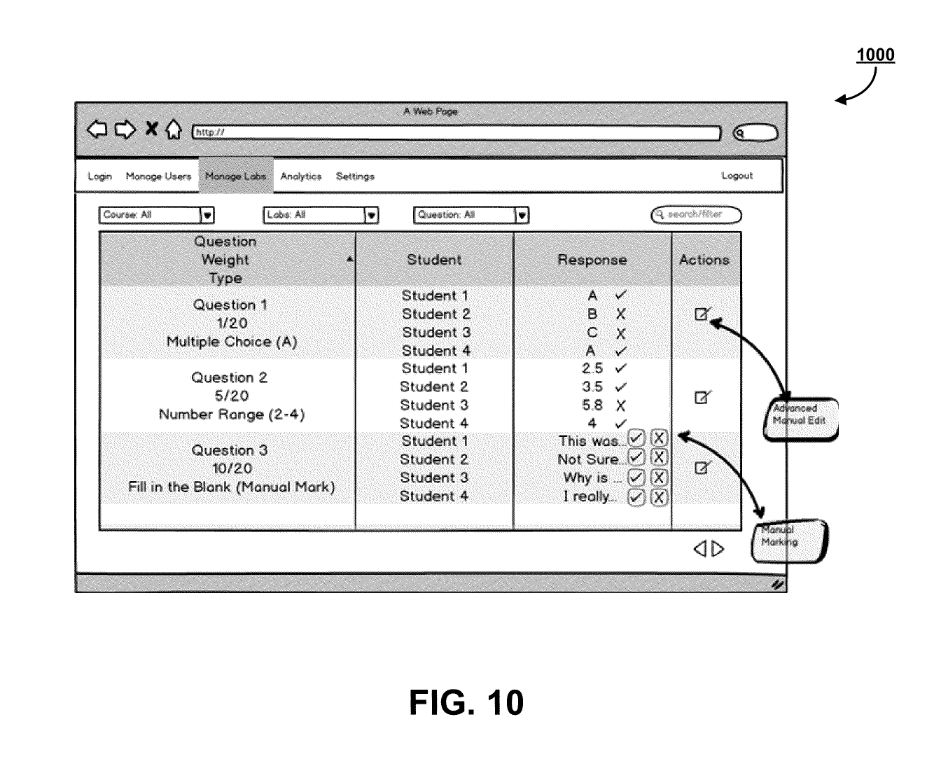

FIG. 10 is an annotated sample layout for marking within a lab manager module, according to some embodiments. The annotations on the figure are example steps provided to aid in understanding.

There may be provisions for automated marking, manual marking, and there may be functionality to provide the ability to conveniently mark a large set of student submitted responses with consistency.

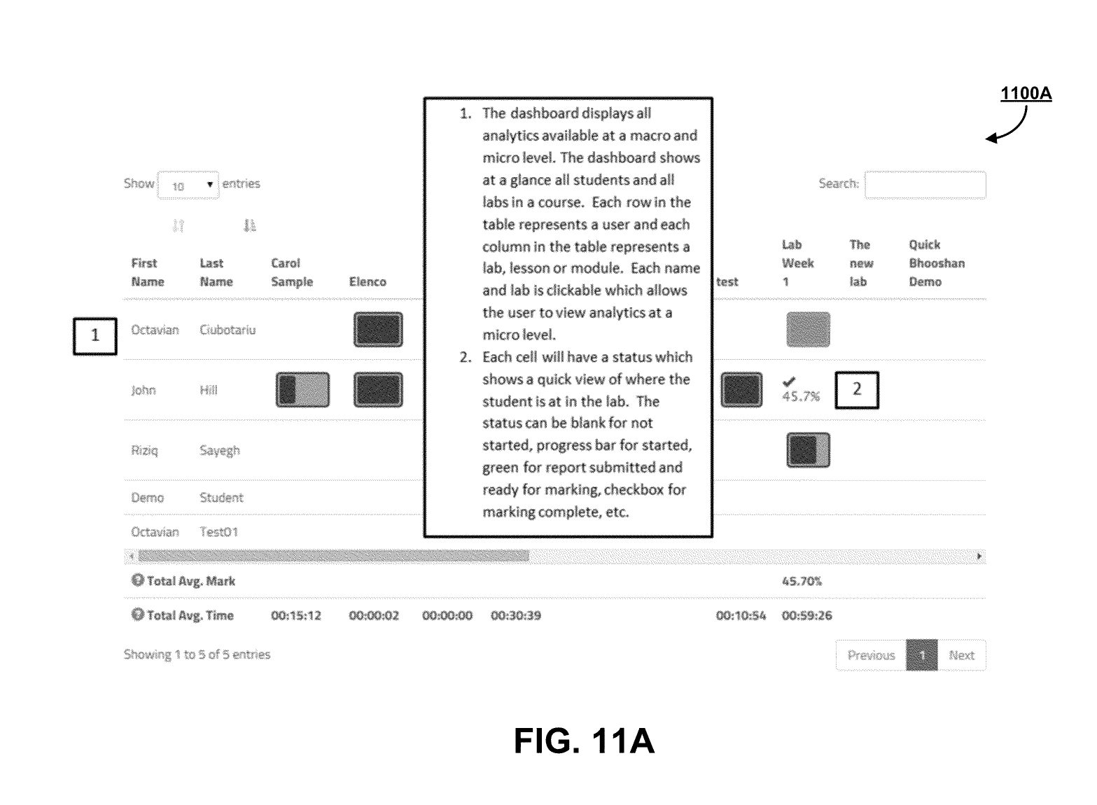

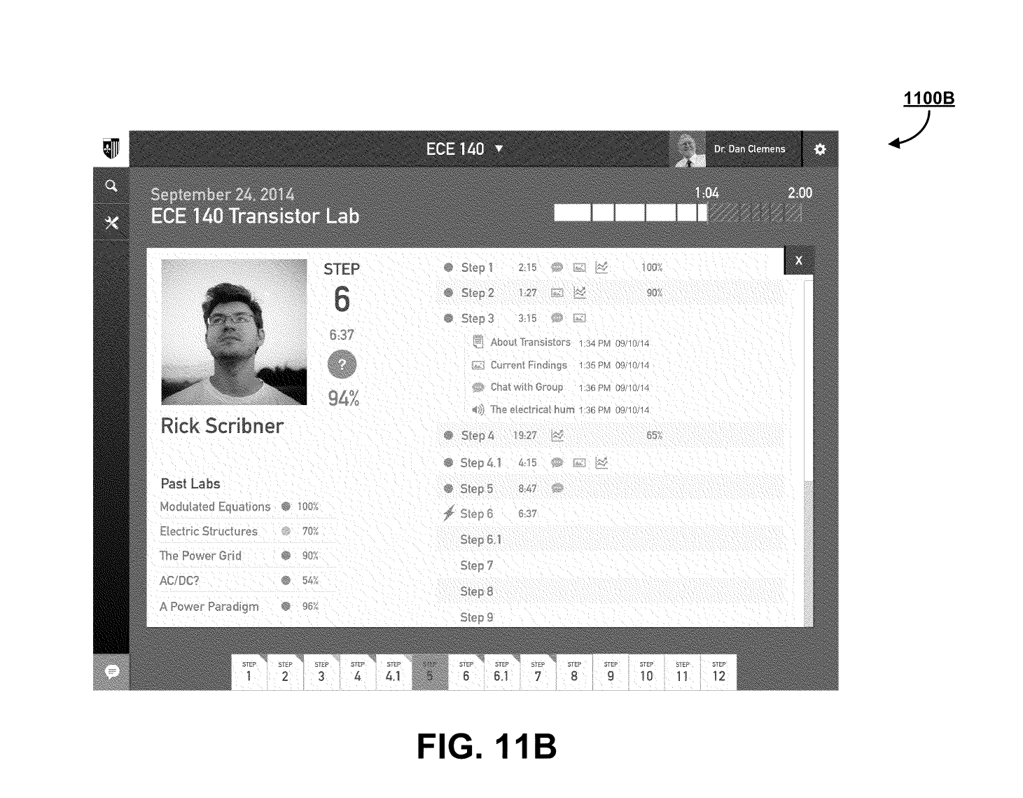

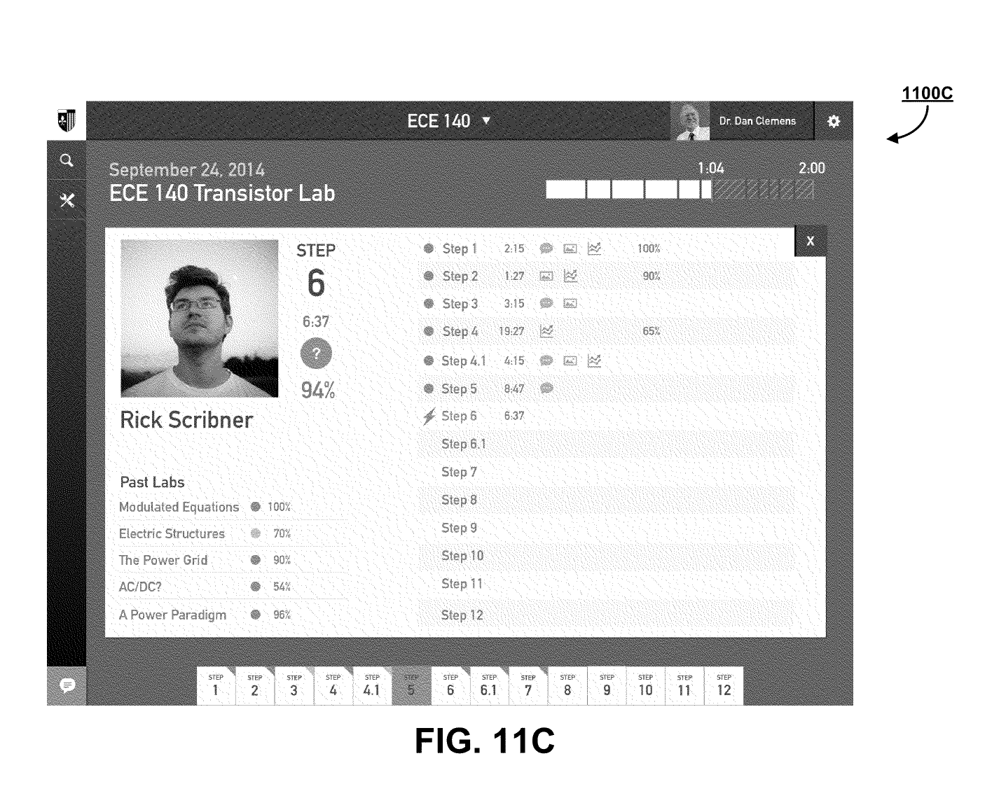

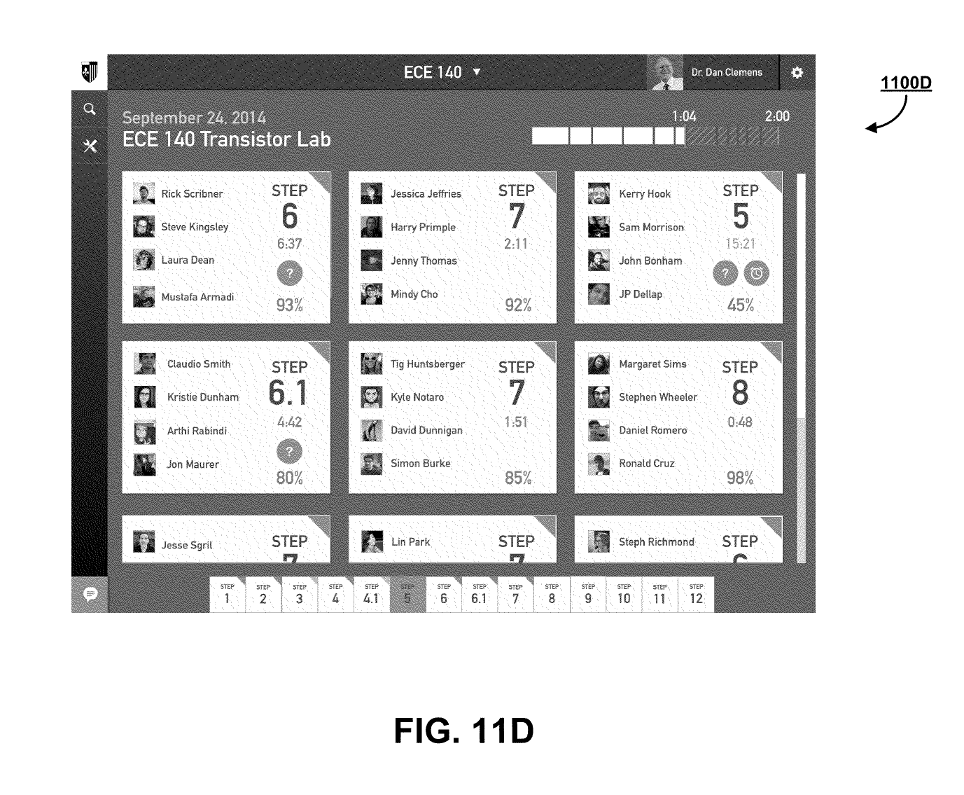

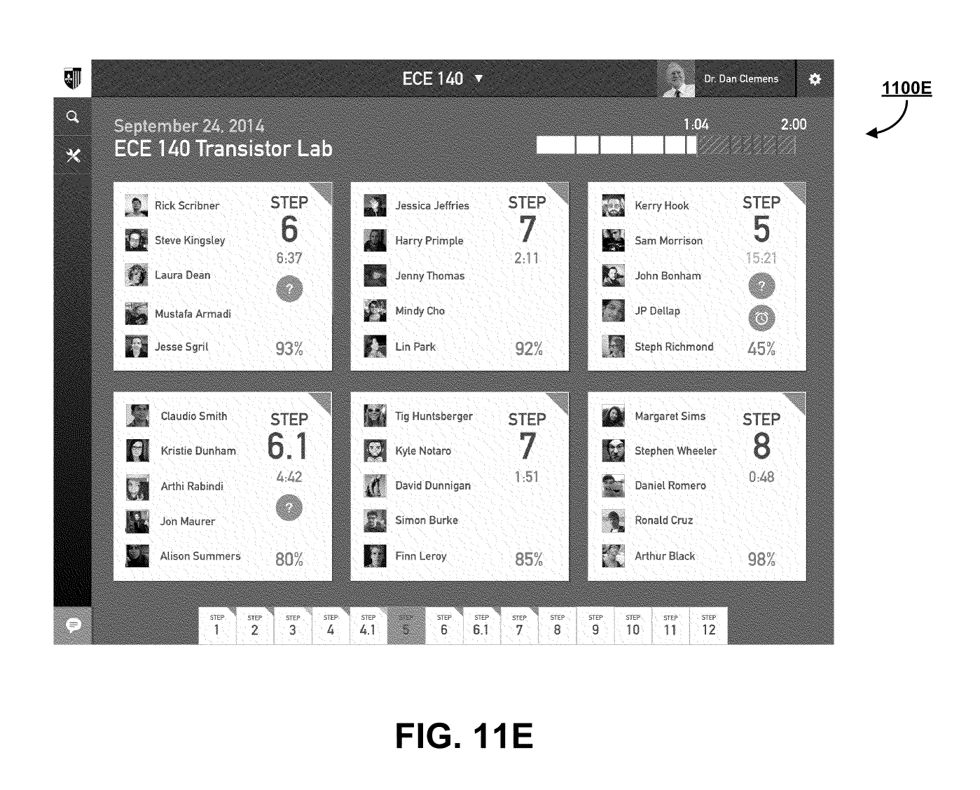

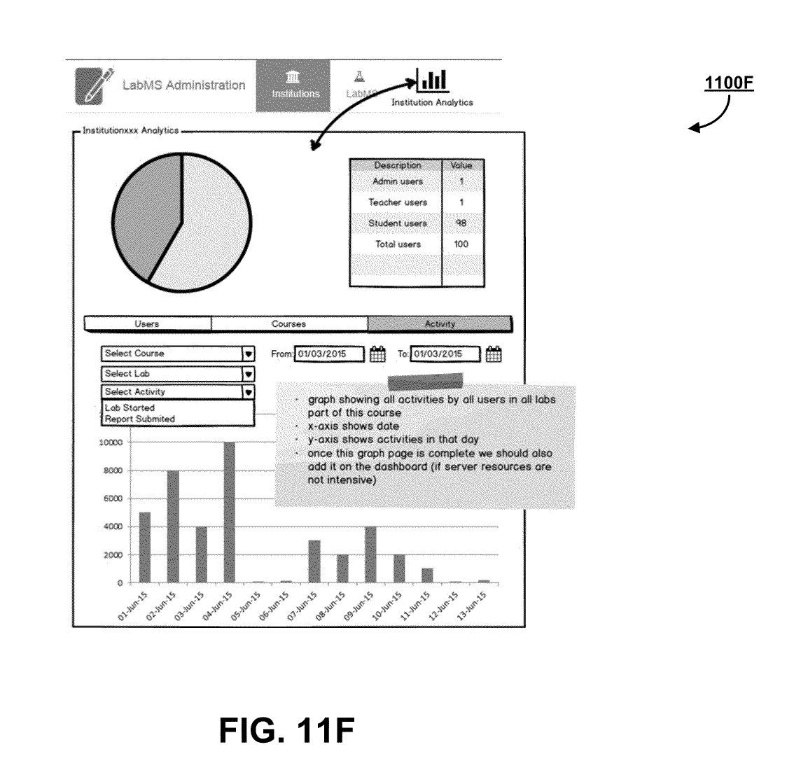

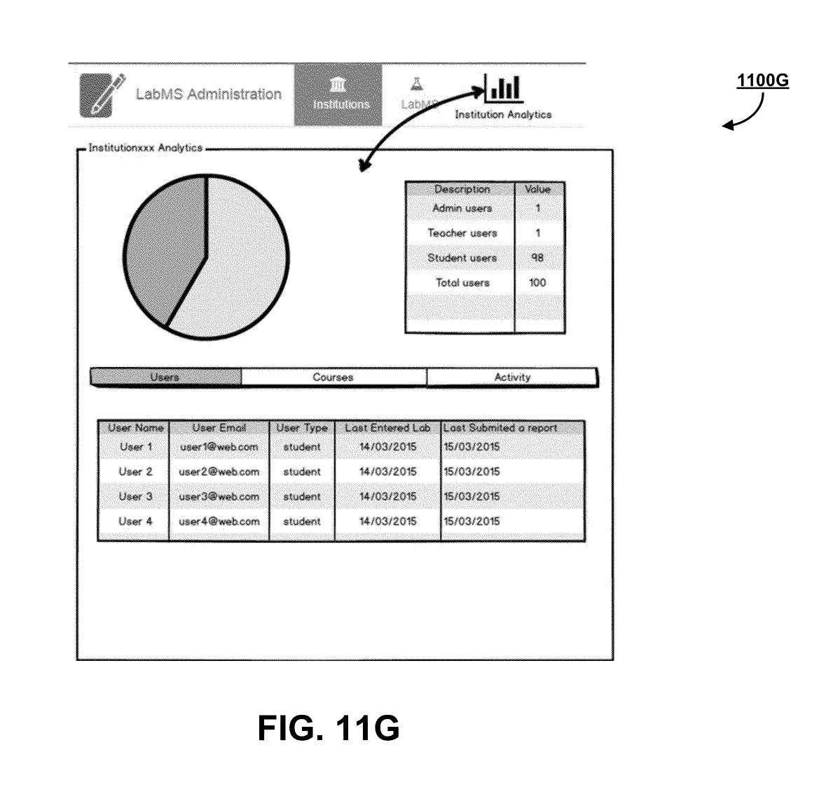

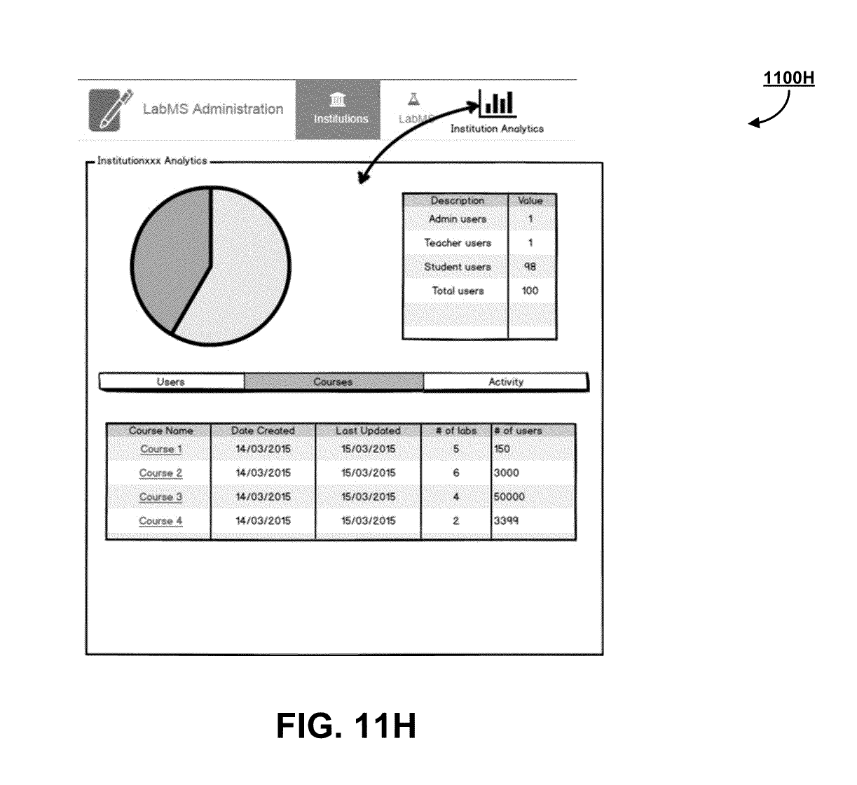

FIG. 11A is an annotated sample dashboard, according to some embodiments. The annotations on the figure are example steps provided to aid in understanding.

For example, the dashboard may be provided by the administrative user interface 202 so that a particular administrative user (e.g., a teacher) is able to view aspects of information associated with student performance, such as their progression through various lap steps, any grading, reports, elapsed time, etc.

FIGS. 11B, 11C, 11D, 11E, 11E, 11F, 11G, and 11H are sample dashboard screenshots, according to some embodiments.

FIGS. 11B and 11C illustrate example teacher dashboards with various aspects of information shown in drill-down format.

FIGS. 11D and 11E illustrate dashboards showing student progression by step.

FIGS. 11F, 11G, and 11H illustrate analytics dashboards with various aspects of information. FIG. 11F contains annotations to describe some features shown.

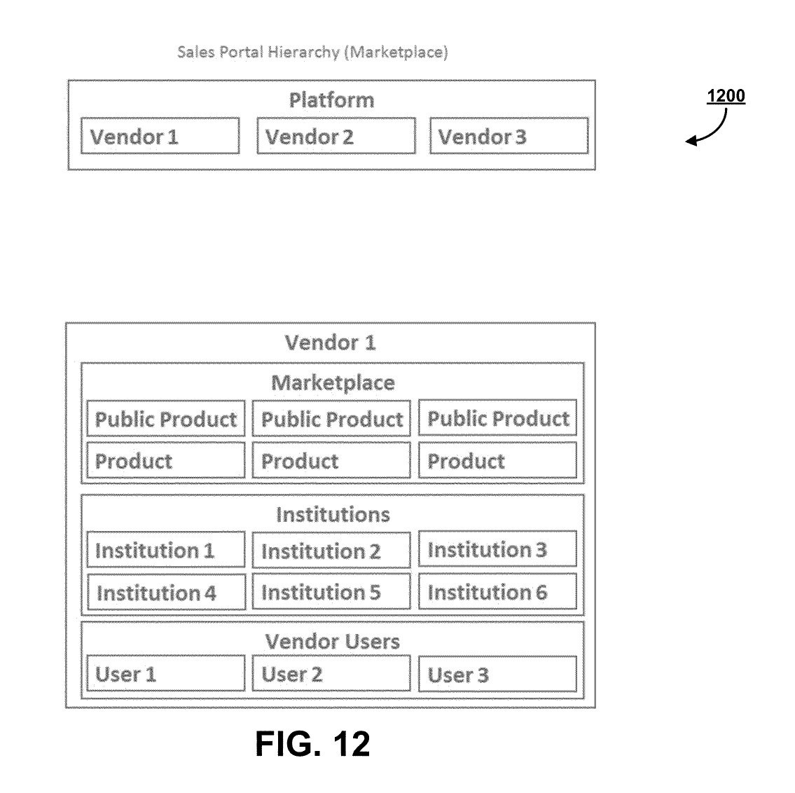

FIG. 12 is a sample sales portal hierarchy, according to some embodiments. FIG. 12 illustrates a sample dashboard layout wherein sales information may be organized in various ways, for example, according to vendors, institutions, vendor users, etc.

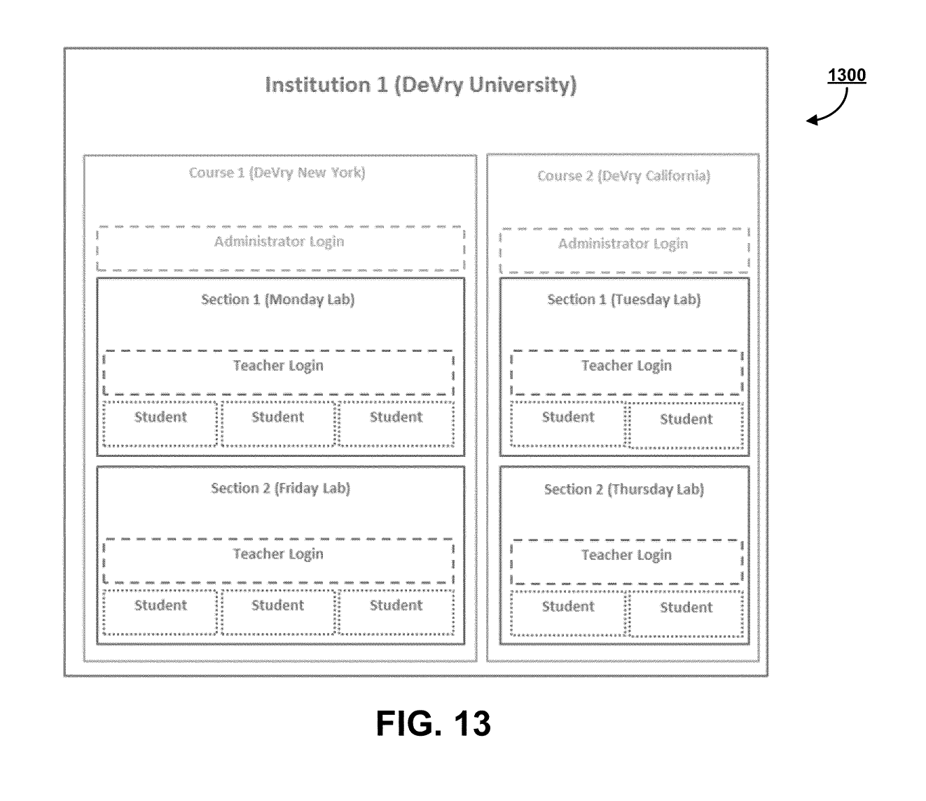

FIG. 13 is a sample institution login page, according to some embodiments. This page, for example, may be designed so information is organized based on particular campuses or courses related to an institution, and may include various administrator logins, teacher logins, student logins, etc.

### Content Marketplace

One or more modules for providing content marketplace functionality may be configured to provide access to purchase, sell and/or share interactive learning content (e.g., labs). Interactive learning content may include authored content (e.g., lab content, workflows, rule sets, multimedia), but may also include various other information, such as notes, analytical statistics, laboratory results, etc. The modules may be implemented in either software or hardware, or both. For example, the modules may be implemented through machine/computer-readable instructions on a processor. In some embodiments, the content marketplace modules may be implemented through cloud-computing techniques and systems.

Content may be purchased, sold and/or shared between colleagues, students, and independent learners. Content may be provided on a streaming-data type platform, and/or provided in a fully downloadable format for use in one or more off-line environments.

The content marketplace modules 18 may provide an interface to support these transactions, and in some embodiments, the content marketplace modules 18 may be configured such that an individual may be able to access his/her shared, own and/or purchased content through the system at his/her own convenience.

The content marketplace modules 18 may also be configured to provide access and/or functionality associated with one or more user accounts, which in turn may be associated with various groupings (e.g., student group, administrator group, University of Toronto group, York University group).

In some embodiments, the content marketplace modules 18 may be configured at a group-level such that content available to an individual in a group may be made available to all individuals in that group (e.g., the teaching assistant in ECE 352 develops material, which is then automatically made available to the teaching assistant in ECE 351, as they operate under the same group at the University of Toronto).

In the following section, several aspects provided by a sales portal and/or marketplace component 18 is described. The content marketplace modules 18 may be configured to automate customer sign-on processes, including facilitating various customer levels for a platform provider and for customers, customers including, for example, the following:

Vendors: these are customers that have content/courses that can be sold to institutions or to users;

Institutions: these are customers that have content/courses that can be sold or provided to users; and

Individual Users: these are customer that buy access to content/courses.

The marketplace component 18 may be designed to handle a large number of transactions with various number of distribution funnels based on product, vendor or institution. For example a transaction from a vendor could be split as follows:

30% of the costs could go to the platform owner, 60% could go to the vendor, 5% could go to the content creator and 5% could go to the ecommerce handler.

The marketplace component 18 may be configured to handle multiple-level hierarchy. For example, the system can setup vendors (Such as National Instruments™) and each vendor can have their own marketplace with their own products. Each vendor can setup institutions (University of Toronto, York University, etc.). Each Institution can setup their own users with different user levels and rights (administrators, teachers, teacher assistants, students, etc.).

The marketplace component 18 may be configured such that a vendor can create their own products (labs, courses, etc.), a vendor can choose to make a marketplace or product available to the public or could restrict it to users under their hierarchy at any level (specific institution, all institutions, specific users, etc.), a vendor can link their own e-commerce account to a marketplace for receiving funds upon sales, and a vendor can create activation codes for institutions for bulk purchases, promotions, etc. The activations codes can be setup to have time restrictions, user restrictions, etc.

Activation codes may be associated with particular integrated learning environments (e.g., a laboratory instruction course, a tutorial) and may have a number of associated seats, a start date, an end date, etc. Activation codes may be generated using a pseudo-random code generator, and/or may be verified from the backend based, for example, on a hash table, a database record, etc. In some embodiments, the activation codes may also include other metadata and/or other information, such as which step a student should start at, student information, associated institution, etc.

### Sample Implementation

Referring to FIG. 2, a sample system architecture diagram illustrating example units that may be used to implement some embodiments is provided.

Sample units described herein may be organized and provided through various elements of hardware and software, individually or in combination. For example, the units may be provided through software modules residing on various elements of hardware, etc.

In a first aspect, the units are provided as servers located remotely from one another to provide a cloud-type system wherein users (e.g., students) are able to utilize various user interfaces to log into the system, and administrators (e.g., lab assistants, teaching assistants, professors, academic observers) may be able to log into the system through suitably configured interfaces.

There may be advantages in grouping units as being provided at different remote locations and/or systems, for example, there may be computational advantages in segregating the student tools 14 from the administrative tools, or to separate the administrative tools (e.g., the authoring tools 12, the manager client applications 16, and the marketplace 18 from another. There may be a single or multiple server stacks and/or computing devices providing this functionality, for example, in a distributed networking-type implementation.

For example, the authoring tools 12 may be provided on a first system or set of computing devices, the manager client applications 16 may be provided on a second system or set of computing devices, and the marketplace 18 may be provided on a third system or set of computing devices. The first, second, and third system or set of computing devices may be provided such that they are interconnected (e.g., over various networking interfaces) but separated. This may be important, for example, where there is sensitive information that needs to be segregated, or where different entities may be providing different services and/or features.

These features can be provided as part of a system 200, embodying various components of the system 200. In some embodiments, they are provided on separate, remotely located servers being connected through network interface 250, for example.

A system 200 may be provided, the system 200 configured to administer one or more remote integrated learning environments, the system having one or more processors, the system 200 comprising an administrative interface unit 202 configured for communication with a first set of remote computing systems being utilized by one or more administrators; a student user interface unit 204 configured for communication with a second set of remote computing systems being utilized by one or more students; an integrated learning environment unit 206 configured to interoperate with the administrative interface unit 202 and the student user interface unit 204. Each of the units may include various sets of machine-readable instructions stored on non-transitory computer readable media, the set of instructions adapted to cause the one or more processors to perform various steps. The system 200 may include one or more databases 230, which may store tracked information, generated information, user preferences, payment / transaction details, etc.

The administrative interface unit 202 may be configured to provide, generate, edit and/or receive document content that is organized into objects within steps in a structure, and specifically, having functionality to reorder, reorganize, and rebuild instructions representative of lab course by manipulating information from high level objects, low level WYSIWG (what-you-see-is-what-you-get) editors and/or word processing environments. The administrative interface unit 202 may be configured to perform various other administrative functions, such as previewing and navigating through thumbnail lab steps that displays a summary of the step, status of any actions/deliverables within a step, a preview of content, as well as which steps have been completed and which have not (e.g., while a laboratory session is in progress). For example, an instructor may utilize the administrative interface unit 202 to create content and to push the content out to client applications based on lab attendance, groups selections, course, etc., as various integrated learning environments are provisioned by the integrated learning environment unit 206. The pushed content can contain assessment questions, HTML content, video, images, etc., and the pushed content may be overlaid over other content is on a client device (e.g., through the student interface unit 204).

In some embodiments, the administrative interface unit 202 may be configured to enable an instructor/administrator to edit content that is currently being used by students in a lab (for example, in case there is a mistake, or edit, or update that needs to occur) and to automatically push an update to the content to one or more student users who are accessing that piece of content, updating content in the background.

The student interface unit 204 may be configured to, for example, provide an ability to access supplemental resources directly within a specific lab step/direction, that is relevant to the concept being learned, provide functionality for providing additional student help during the implementation of an interactive learning experience; and functionality to save, on a periodic basis, action and edits.

The integrated learning environment unit 206 may be configured to generate instructions to be performed by the student interface unit 204 in providing various interfaces (e.g., graphical user interfaces), that provide interactive learning steps whose steps may be organized, steps having content that can be created and/or associated within them, and the order and types of object within each step can be manipulated.

The system 200 may be configured to receive electronic instructions representative of learning materials from the administrative interface unit 202. These electronic instructions may be in various forms, such as in a hypertext markup language file (HTML), extended markup language file (XML), binary code, compiled program code, spreadsheets, flat files, database records, relational database records, non-relational database records, etc.

These electronic instructions may be provided, for example, in various schemas and formats configured for providing laboratory style instruction through an “integrated learning environment”. Such instruction may have been conducted traditionally through pen and paper, or through using various machines, with students listening to oral and/or verbal steps from teaching assistants. The system 200 may be configured such that these electronic instructions can be machine-readable and/or interpretable such that steps can be automatically extracted.

For example, the electronic instructions may include various tokenized and/or symbols utilized as separators (e.g., tags, metadata, simple symbols being used for delineation) and the electronic instructions may be designed such that the electronic instructions are easily parse-able into specific steps. In some embodiments, the electronic instructions further include one or more symbols or indicia indicating linkages between various steps of a lab, and the linkages themselves may indicate non-linear steps and/or other types of connections, such as necessary and/or sufficient conditions to be able to move on and/or progress. In some embodiments, the linkages are designed such that the linkages may indicate various alternatives, having various rules and/or logical conditions provided. For example, in some embodiments, fulfilment of a first set of conditions may lead to a first linkage being used, fulfilment of a second set of conditions may lead to a second linkage being used, etc.

Such an embodiment may be used to segregate students and/or provide laboratory instruction having progression speeds based on student achievement (e.g., the highest performing students may be able to progress through and skip various steps, while on the other hand, lower or average performing steps may be able to progress through with additional steps so as to help solidify a particular concept or notion). Further, such conditions may be provided to also enable system 200 to automatically determine (e.g., using a confidence interval or using various weighted parameters) that a student has not actually completed a particular step, or is possibly cheating (e.g., the student completed steps too quickly, the information posted by the student as evidence of completion is questionable or clearly copied from another student).

In some embodiments, there may be a parsing unit 208 configured for automatically parse the electronic instructions to extract a plurality of steps to be performed by the one or more students.

Each step of the plurality of steps may be designed such that there are linkages to at least one other step, the linkages indicating progression between the steps of the plurality of steps. Progression may be in the form of information provided to the system 200 through the student user interface 204, such as the uploading of a photograph (e.g., a photograph of a positive result), the answering of a particular keyword or puzzle (e.g., enter a password), a particular achievement, a physical condition being detected by a sensor (e.g., a probe detects that a particular chemical was synthesized, an oscilloscope detects that a passable signal is being provided), etc. In some embodiments, there may be an external system and/or device which may be suitably configured to issue a control signal indicating to the system 200 that a particular condition may have been achieved, and a student may progress on. In some embodiments, the conditions and/or control signals provided may be encoded such that a hidden signal, unknown to the student may be provided to indicate the student's performance and/or ranking relative to his/her peers. For example, where progression is provided through having a computer program execute a particular function having a performance characteristic, the computer programming interface where a student was writing code may be configured to pass on characteristics of the student's programming project (e.g., number of lines of code, speed of execution, achievement of primary/secondary/n-tiary objectives, amount of time required to code, number of coding exceptions encountered, number of attempts, cleanliness of code, amount of memory used, amount of memory unallocated, processing power required, among others). Accordingly, these performance characteristics may be utilized to determine progression and/or differentiated progression (e.g., to aid gifted students in a faster progression to higher levels of difficulty).

Progression may also be in the form of information provided through the administrative interface unit 202, for example, a laboratory teaching assistant indicating that the student is in a position to pass through (e.g., through visual inspection of a circuit), etc. Similarly, information may be provided through the administrative interface unit 202 indicating characteristics of performance, which the system 200 may automatically use to determine progression through various steps.

In other words, traversal of steps may be not only be non-linear but may be different from student to student, and based on various characteristics of performance. Various types of triggers (manual/automatic/combination) as set by a content author may be utilized, etc.

In some embodiments, the electronic instructions include various information, such as at least graphical information to be displayed through the student user interface unit 204 for each step of the plurality of steps. In some embodiments, the electronic instructions further include instructions directed towards conditions for success, interface requirements with other devices, conditions for success based on automatically sensed outputs from other devices, etc.

The integrated learning environment unit 206 may automatically provision, to the student user interface unit 204, one or more remote integrated learning environments having at least the plurality of steps, the one or more remote integrated learning environments provided for use by the one or more students through the student user interface unit 204, each of the plurality of steps triggering the provisioning of a corresponding state by the student user interface unit 204.

In some embodiments, a timer 210 may be utilized to track elapsed times. There are other types of aspects that may be tracked, for example, the amount of activity is being undertaken by a student (e.g., by tracking mouse movements, keystrokes, device inputs / outputs), etc. These aspects may correspond to various usage characteristics (e.g., one or more elapsed times, each of the elapsed times corresponding to an amount of time the student user interface unit 204 has remained in a corresponding state).

The integrated learning environment unit 206 may be configured to, based on the linkages between the steps of the plurality of steps, switch states between the steps of the plurality of steps when sufficient indications of progress are received through the student user interface unit 204, triggering changes of state by the student user interface unit 204.

The integrated learning environment unit 206 may be configured to provide a series of visual indicators, each of the visual indicators indicative of each step of the plurality of steps, and provide, in a first format, a visual indicator of the series of visual indicators associated with a current step being provided by the student user interface unit 204; and provide, in a second format, visual indicators of the series of visual indicators associated with steps already traversed by the student user interface unit 204.

Formats, may include highlighting, colors, magnification of the visual indicator, hatchings, etc. These formats may be provided so that a student or administrator may more readily be able to distinguish between steps to be taken, steps already taken, a current step, etc. These indicators may also be configured such that performance attributes may be visually indicated (e.g., a student achieved a 90% score on a particular step), and potentially also indicative of the student's progression path through various steps, especially where the steps are non-linear in nature. In some embodiments, students may, through the student user interface unit 204, be able to revisit old steps and/or attempt to obtain a higher level of achievement.

In some embodiments, there may be a transaction unit 212, the transaction unit 212 configured to receive one or more requests to provision one or more selected remote integrated learning environments from the student user interface unit 204, each of the one or more selected remote integrated learning environments having a number of available positions.

The transaction unit 212 may be configured such that students and/or other users may be able to purchase spots in a particular integrated learning environment if such spots are available. For example, the transaction unit 212 may be configured to determine whether there is availability in the one or more selected remote integrated learning environments by determining whether any of the one or more selected remote integrated learning environments has the number of available positions greater than 0; and if the number of available positions is greater than 0 for the one or more selected remote integrated learning environments, receive an indication of payment from the student user interface unit 204, cause the provisioning of the selected one or more selected remote integrated learning environments having the number of available positions greater than 0 through the student user interface unit 204.

In some embodiments, the transaction unit 212 may be configured for the distribution, selling, and/or sharing of various documents, learning sessions, information and/or workflows created within the system 200.

In some embodiments, the system 200 may be configured to enable users to share notes, images, videos, observations, results and any other activities and assets, within groups or with individual users. This information can be cross-validated, for example, through the various student user interface units 204, and the cross-validation may be utilized as an indicia of progression. For example, group member may be able to evaluate the results of other group members of a student group, and such results may be useful in determining which students and/or student groups should be allowed to progress to another step.

The provisioning of the selected one or more selected remote integrated learning environments may be performed, for example, by controlling the transaction unit 212 to generate one or more activation codes, each of the one or more activation codes being adapted to control access to the selected one or more remote integrated learning environments being provisioned, decrement the number of available positions for each of the one or more provisioned remote integrated learning environments by one, cause a first electronic payment to be provided to a service provider, the first electronic payment transferring funds corresponding to a first portion of the received payment; and cause a second electronic payment to be provided to a content provider, the second electronic payment transferring funds corresponding to a second portion of the received payment.

In some embodiments, the student user interface unit 204 is configured to provide just-in-time help through the student user interface unit 204. Just-in-time help may be provided in various contexts—for example, the help may be provided in the form of simply generating a notification to a teaching assistant through the administrative interface unit 202. In other embodiments, help may be provided in the form of context-aware clues that may be automatically generated based on a reference set of help guidelines wherein, based on the detection of various conditions, help may be automatically provisioned (e.g., where a resistive load only has a current of 500 mA flowing through it, the system 200 may indicate that such a condition occurs when switch 1 is not properly controlled (e.g., a correct current should be 10 A), and therefore system 200 may generate an automatic suggestion that the control of switch 1 should be considered in more detail). In some embodiments, the student user interface unit 204 is configured to learn, from various devices, where students have generally requested help and to further identify what other students have been able to modify in their laboratory activities in traversing a particular problem. In such an embodiment, the system may be configured to, over a period of time, learn and refine its suggestions accordingly.

For example, the system may provide a “just-in-time help window” that can be set up for conditional release based on the student progress throughout the lab and answers to evaluation/assessment questions during the lab, or that can be triggered manually by the lab instructor, or be setup to trigger/become available after a predefined time.

In some embodiments, the just-in-time help is provided when the student user interface unit 204 receives a request for help (e.g., a student clicks on a part of the interface having a button requesting help).

In some embodiments, the student user interface unit 204 is configured to determine, e.g., using a timer, that the student user interface unit 204 has remained in a state beyond a pre-defined threshold of time (e.g., over 10 minutes, for a task that normally takes 5 minutes). In some embodiments, the threshold of time is not predefined but rather modified and/or analyzed and/or determined based on the aggregate amount of time other users (e.g., of a similar educational background or achievement level) have taken on the step. In some embodiments, where a large number of students have lingered on a step for too long, a notification is automatically generated to the administrative interface unit 202 (e.g., there may be a problem with the design of a step). In some embodiments, if the system 200 determines that a large number of students have lingered on a step for too long, the conditions for obtaining progression may be automatically relaxed (e.g., a condition may be too difficult for students to achieve). Conversely, if the system 200 determines that a large number of students have progressed from a step too quickly, the conditions for obtaining progression may be automatically tightened (e.g., a condition may be too easy for students to achieve).

In some embodiments, the system 200 includes an automatic report generating unit 213, the automatic report generating unit 213 extracting various information input by the student and/or other devices (e.g., oscilloscope readings) and automatically generating a laboratory report having information recorded related to the student's progression through the steps. These may, for example, include any/all student responses to questions within the lab, and any/all notes taken by the student and group members. In some embodiments, the automatic report generating unit 213 may also be configured to provide these reports to various interfaces 202 and 204.

In some embodiments, the system 200 includes an automated grading unit 214, the automated grading unit 214 configured to receive an electronic instruction from the administrative interface unit 202 to generate one or more grade reports, and automatically generate the one or more grade reports. These grade reports may be generated based on grading conducted by the automated grading unit 214 and the grading may be automatically conducted through various determinations, for example, based on the characteristics of the students' progression through the various steps, the speed of progression, the type of progression (e.g., barely achieving or obtaining stellar results), whether the students required help, whether help was effectively utilized, etc.

For example, each of the grade reports may include grades based at least on the one or more elapsed times corresponding to the amount of time the student user interface unit 204 has remained in a corresponding state, and the automated grading unit 214 may be configured to provide the one or more grade reports through the administrative interface unit 202; and provide the one or more grade reports through the student user interface unit 204.

In some embodiments, the automated grading unit 214 is further configured to track indications of progress across an aggregate of students; and wherein the grades included in the grade reports are based at least on a comparison of (i) the indications of progress across the aggregate of students and (ii) the indications of progress received through the student user interface unit 204 for a particular student. In the case of automatic marking, an instructor would be able to validate the automatic marking, and in the case of manual marking, can assign full or partial marks. In some embodiments, the automated grading unit 214 may overlay and/or otherwise display the marking rubric for each question while engaging in marking.

In some embodiments, the automated grading unit 214 may configured to enable instructors to view and determine the amount of original and copied content in a user's account. For example, various aspects of performance that are automatically tracked may be associated with one or more time stamps, and the earliest time stamp may be utilized to identify a result originator. Where a student uploads a similar deliverable, similar to another student's deliverable to the system 200, the automated grading unit 214 may be triggered to (i) check the timestamps to identify the first deliverable, (ii) compare the deliverables to identify similarities and/or differences, (iii) trigger a workflow if there is a high level of correlation (e.g., a predefined level, a threshold). In some embodiments, the automated grading unit 214 may configured to track group participation through indirectly measuring a student's contribution to various achievements required to progress through steps.

In some embodiments, an analytics unit 216 may be provided, the analytics unit configured to perform various determinations based on received information (e.g., student's notes), tracked information (e.g., student's progression and/or elapsed time per step), and/or user profile information (e.g., student name and grade). For example, the analytics unit 216 may be configured to parse sets of data to display macro-level and micro-level analytics at various points in time or on demand.

An administrative user may be able to perform analytics, for example, starting at a high level for example at an institution level and drill down to an individual student level. The user may be provided average lab times based on an institution sample, classroom sample, group sample or individual student (e.g., by stage, by progression). The user can also be displayed the activity levels of each student and how much they have participated in at a group level (e.g., elapsed time, interactions with others, tracked stage progression, reports uploaded).

The administrative user (e.g., a teacher) may, for example, be able to provide participation marks based on this data, or other types of marks, which may be taken into consideration later, for example, by the automated grading unit 214. Through the administrative user interface unit 202, the teacher may be provided an interface wherein the teacher may see notes, live assessments answers and current step status, allowing them to intervene as needed (e.g., providing “just-in-time” help, modifying step progression criteria, changing help messages) and help the students in need. Through the administrative user interface unit 202 in cooperation with the analytics unit 216 and accessing a database 230, the teacher would also have access to previous data and can make decisions based on live comparisons of data. For example student-a has always progressed through labs faster than student-b and student-a is a 90% average student. With this data, the teacher can choose which students he/she needs to focus on. In some embodiments, the analytics unit 216 may be configured to automatically identify students requiring focus based at least on aspects of automatically tracked performance (e.g., elapsed time, quality of results, level of interaction, potential for fraud). The automatic identification of students, for example, may be particularly helpful in scenarios where there are no administrators monitoring individual students or where online-only courses provided to a large number of participants.

The analytics unit 216 may also be utilized to include aspects of predictive analytics, including and/or enabling parsing algorithms to support both server-side parsing, as well as client-side parsing. With the predictive analytics, the analytics unit 216 may be configured such that users may be able to drill down into large data sets with a sufficient speed such that to the user, the analysis appears to be real or near real-time (e.g., in particular if data is local). The predictive analytics may have multiple applications, which may aid in increasing analytics use exponentially. The various user interfaces and data parsing aspects may be configured to handle analysis of large amounts of data. For example, the analytics unit 216, using predictive analytics may be configured to indicate to users ahead of time, based on existing data, what content the user needs to focus or work on, predict marks based on current status and/or workflow, predict completion times, etc. This can be displayed to both an administrator (e.g., a teacher) and/or the student users. Additionally the analytics unit 216 may be configured to identify to the users what might be of interest to them based on previous actions within the system and platform. This can be related labs, products, etc. Additionally through the analytics unit 216, the system 200 may be able to make suggestion based on previous actions.

### Workflows

In some embodiments, a report creation process is provided, where:
Students answer in-line assessment questions and take notes while consuming the content provided.
Once they are finished with the lab, lesson or module, the student can generate a digital report.
The student clicks the report button.
By default the report generator includes an area for each step in the lab, lesson or module.
By default all in-line assessment are attached to the report.
The report generator shows all available notes and observations that the student had made for the lab, lesson or module. The student can choose to include any notes or observations as part of the report. Additionally the student can include any media such as files, images or videos.
The report generator allows the student to write an Introduction and a conclusion as part of the report.
The report generator allows the student to write additional observations for each step as part of the report.
The report generator allows the student to show/hide report portions such as: assessments, notes, observations.
The report generator shows the student how he/she is being marked, but displaying the rubric that the teacher has created for the lab, lesson or module.
The student can submit the report once completed.
The lab, lesson or module will present the student with a report due date. If the current date and time is past the due date, the student will not be able to complete or submit a report unless the teacher bypasses the system.
Once the report is submitted the lab, lesson or module will display this information to the student and will be marked as complete.
Once the teacher marks the report, the student receives a notification and the student will be able to see his/her mark on the lab, lesson or module tile. Additionally, the student can click and view the complete report feedback from the teacher. This includes marking breakdown , teacher comments and feedback, etc.
Optionally the teacher can enable report re-submission on a user by user basis which will allow students to make changes and adjustments as needed and resubmit their report for marking.

In some embodiments, a report marking process is provided, where:
Once the teacher has completed the lab, lesson or module, he or she can provide the students with a report due date
Optionally, the teacher can create a rubric using the rubric editor
Once the student has submitted a report, the teacher will receive a notification or he/she can see the status in the dashboard.
The teacher can open a report using the report marking tool.
The teacher will be able to see the student's digital report as well as any data collected by the system for the specific student and lab, lesson or module.
the report marking tool can auto-mark any assessment type questions such us short-answer or multiple choice.
The teacher can manually over-ride and adjust marking as needed.
The teacher can provide comments and feedback to students for each step, for each assessment question, for the report introduction/conclusion and for student's notes.
Optionally the teacher can enable report re-submission on a user by user basis which will allow students to make changes and adjustments as needed and resubmit their report for marking.

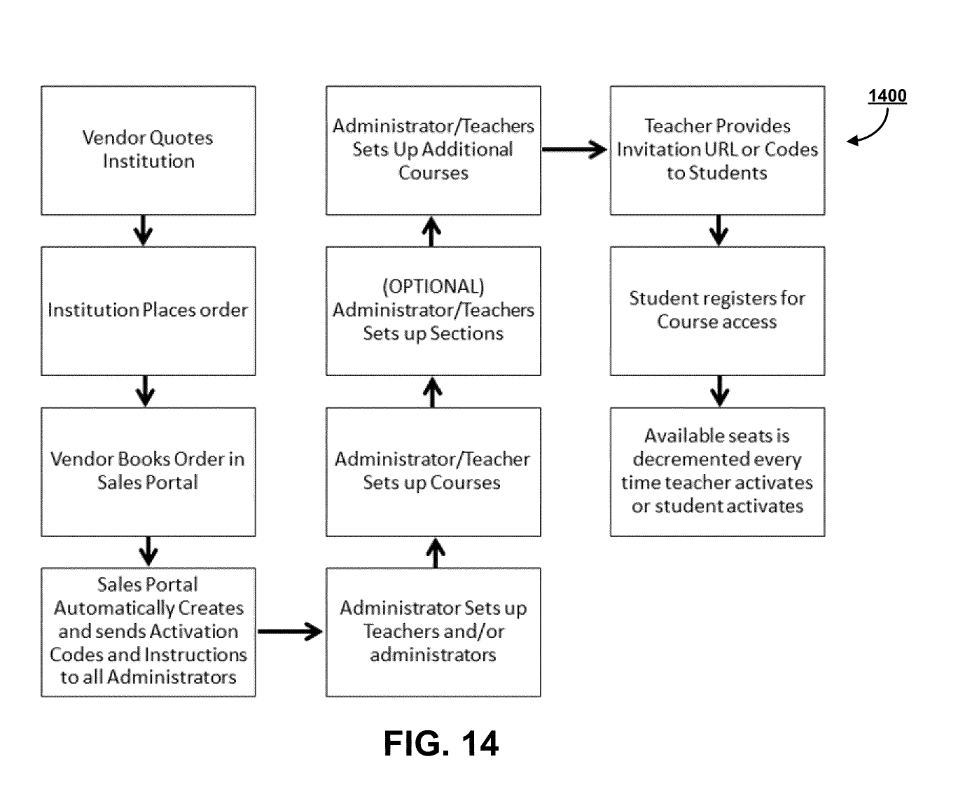

FIG. 14 is a workflow illustrating sample steps in provisioning a learning environment, according to some embodiments.

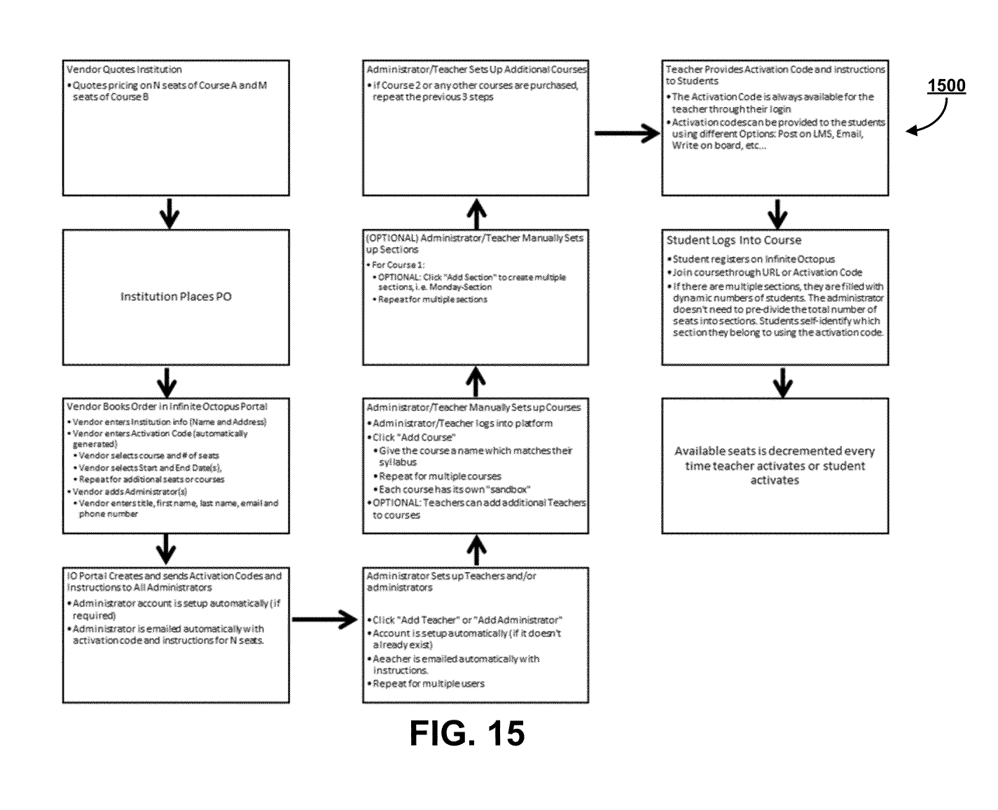

FIG. 15 is a detailed workflow illustrating sample steps in provisioning a learning environment, according to some embodiments.

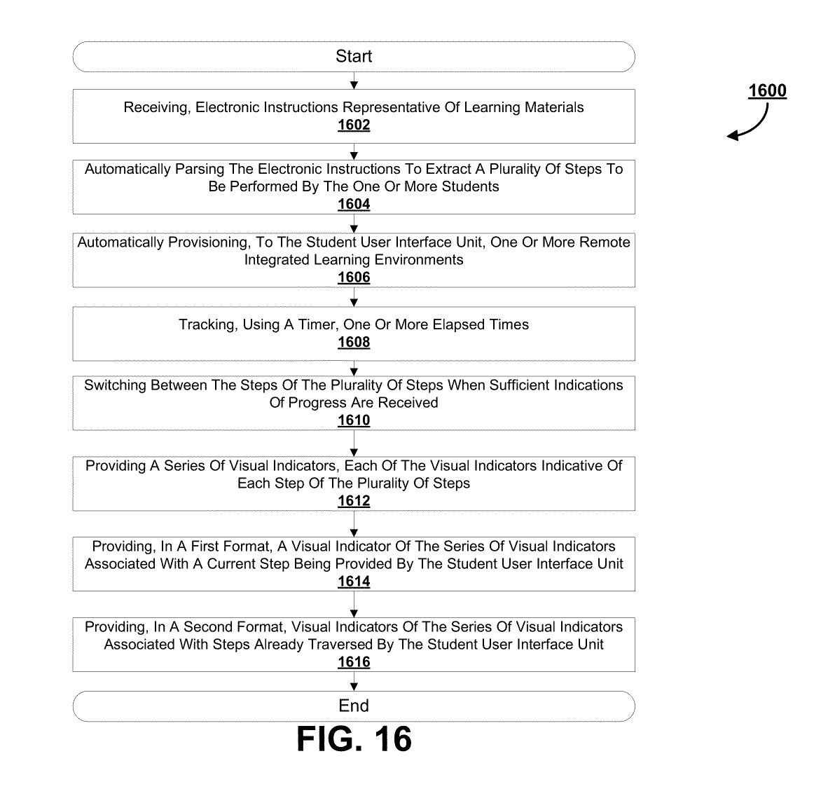

FIG. 16 is a workflow illustrating sample steps in provisioning a learning environment, according to some embodiments. Steps 1602, 1604, 1606, 1608, 1610, 1612, 1614, and 1616 are sample steps that may be performed to provision one or more selected remote integrated learning environment based on electronic instructions received, the electronic instructions representative of learning materials.

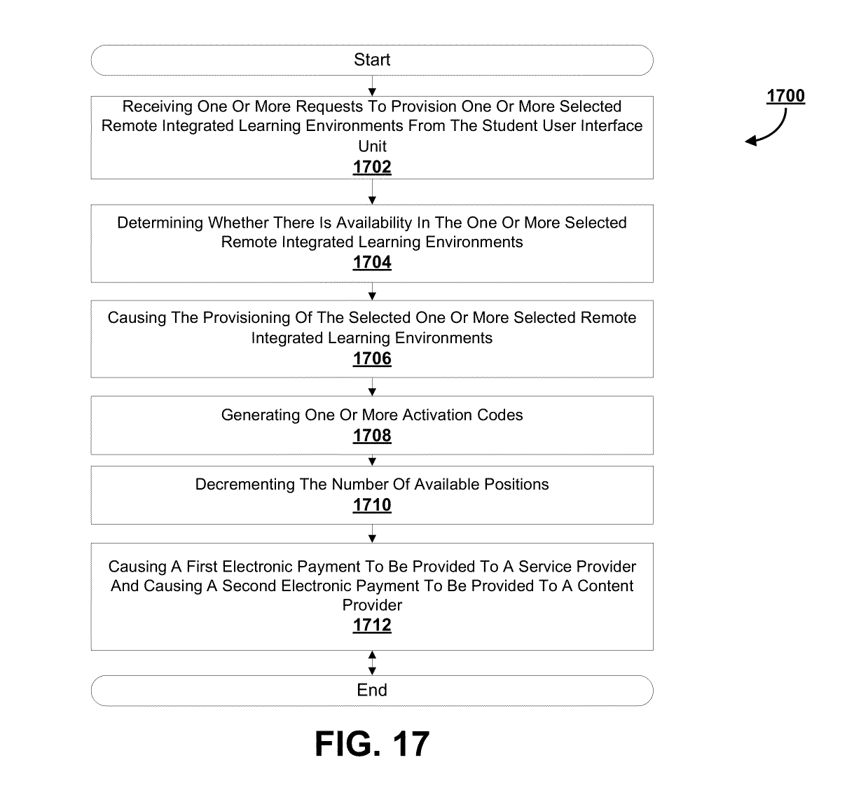

FIG. 17 is a workflow illustrating sample steps in provisioning a learning environment, according to some embodiments. Steps 1702, 1704, 1706, 1708, 1710, and 1712 are sample steps that may be performed, for example, when a request to provision one or more selected remote integrated learning environments is received.

### General

Some embodiments described herein may be provided to adduce functionality for consumption by individuals, such as users, administrators, etc., and may also be utilized in conjunction with various physical apparatuses, such as laboratory equipment, external databases, etc.

Some commercial advantages available may include increased learning outcomes, reduced cost and investment into learning management system infrastructure and the development of a marketplace wherein various information related to interactive learning may be shared, sold, or otherwise distributed. Increased coordination between students and/or educators may also be provided through practicing various embodiments.

With respect to computer-implemented embodiments, the description provided may describe how one would modify a computer to implement the system or steps of a method or modules. The specific problem being solved may be in the context of a computer-related problem, and the system may not be meant to be performed solely through manual means or as a series of manual steps.

Computer-related implementation and/or solutions may be advantageous in the context of some embodiments; at least for the reasons of providing scalability (the use of a single platform/system to manage a large number of activities); the ability to quickly and effectively pull together information from disparate networks; improved decision support and/or analytics that would otherwise be unfeasible; the ability to integrate with external systems whose only connection points are computer-implemented interfaces; the ability to achieve cost savings through automation; the ability to dynamically respond and consider updates in various contexts (such as the real-time or near real-time ability to conduct an assessment); the ability to apply complex logical rules that would be infeasible through manual means; the ability for educators and/or students to be truly anonymous (e.g. when asking a sensitive question to an administrator); among others.

Using electronic and/or computerized means can provide a platform that may be more convenient, scalable, efficient, accurate, and/or reliable than traditional, non-computerized means. Further, many external systems for interactive learning off may be computerized and the platform may advantageously be designed for interoperability, and manual operation may be difficult and/or impossible.

Scalability may be useful as it may be advantageous to provide a system that may be able to effectively manage a large number of users and/or interconnections and/or integration with external systems.

A cloud-based implementation for learning management may provide one or more advantages including: openness, flexibility, and extendibility; manageable centrally; reliability;

scalability; being optimized for computing resources; having an ability to aggregate information across a number of users; and ability to connect across a number of users and find/filter for various criteria. While embodiments and implementations may be discussed in particular non-limiting examples with respect to use of the cloud to implement aspects of the system platform, a local server, a single remote server, a software as a service platform, or other computing devices may be used instead of the cloud.

The convenience and effectiveness of a solution may be valuable in the context of interactive learning as the learning outcomes may often be sensitive to the perceived difficulty and administrative burden involved in the interactions. The convenience and ease of use may lead to improved learning outcomes.

As will be further understood by those skilled in the relevant arts, significant advantage may be realized through the full or partial automation of the processes described above, or portions thereof. Such automation may be provided in various manners, including for example the use of automatic data processors executing suitably-configured, coded, machine-readable instructions using a wide variety of devices, some of which are known and others of which will doubtless be developed hereafter. Processor(s) suitable for use in such implementations can comprise one or more data processor(s), computer(s), and/or other system(s) or device(s), and necessary or desirable input/output, communications, control, operating system, and other devices or components, including software, that are suitable for accomplishing the purposes described herein. For example, a suitably-programmed general-purpose data processor provided on one or more circuit boards will suffice.

It will be appreciated by those skilled in the art that other variations of the embodiments described herein may also be practiced. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made.

Except to the extent explicitly stated or inherent within the processes described, including any optional steps or components thereof, no required order, sequence, or combination is intended or implied. As will be understood by those skilled in the relevant arts, with respect to both processes and any systems, devices, etc., described herein, a wide range of variations is possible, and even advantageous, in various circumstances.

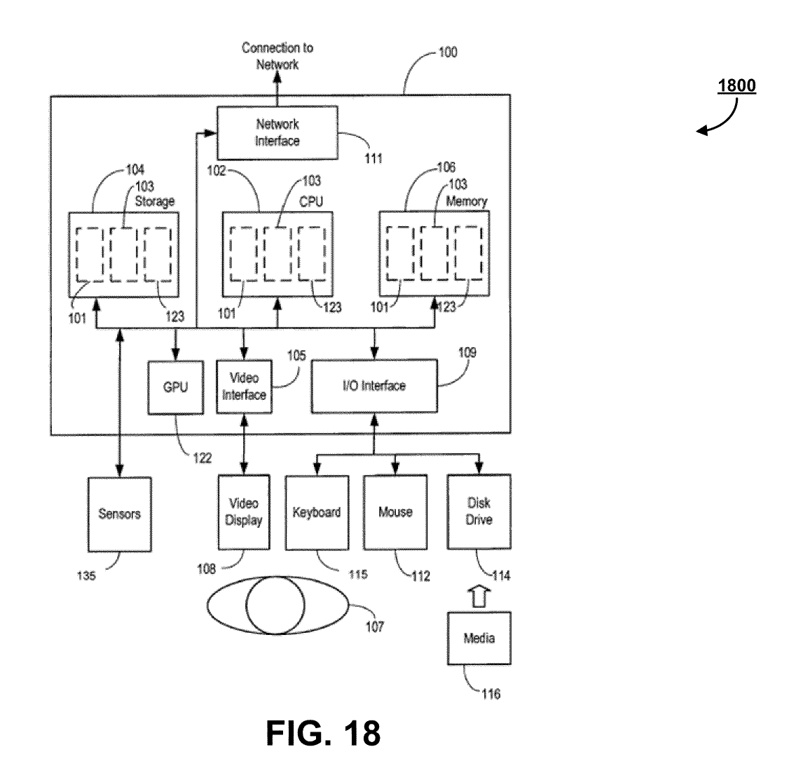

The present system and method may be practiced in various embodiments. A suitably configured computer device, and associated communications networks, devices, software and firmware may provide a platform for enabling one or more embodiments as described above. By way of example, FIG. 18 shows a computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 135 may be used to receive input from various sources.

The present system and method may be practiced on computing devices including a desktop computer, laptop computer, tablet computer or wireless handheld. The present system and method may also be implemented as a computer-readable/useable medium that includes computer program code to enable one or more computer devices to implement each of the various process steps in a method in accordance with some embodiments. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g.

an optical disc, a magnetic disk, a tape, etc.), on one or more data storage portioned of a computing device, such as memory associated with a computer and/or a storage system.

The mobile application may be implemented as a web service, where the mobile device includes a link for accessing the web service, rather than a native application.

The functionality described may be implemented to any mobile platform, including the iOS™ platform, ANDROID™, WINDOWS™ or BLACKBERRY™.

It will be appreciated by those skilled in the art that other variations of the embodiments described herein may also be practiced. Other modifications are therefore possible.

What is claimed is:

1. A system configured to administer one or more remote integrated learning environments, the system having one or more processors, the system comprising:
an administrative interface unit configured for communication with a first set of remote computing systems being utilized by one or more administrators;
a student user interface unit configured for communication with a second set of remote computing systems being utilized by one or more students;
an integrated learning environment unit configured to interoperate with the administrative interface unit and the student user interface unit, the integrated learning environment unit including a set of instructions stored on non-transitory computer readable media, the set of instructions adapted to cause the one or more processors to:
receive electronic instructions representative of learning materials from the administrative interface unit;
automatically parse the electronic instructions to extract a plurality of steps to be performed by the one or more students, each step of the plurality of steps having linkages to at least one other step, the linkages indicating progression between the steps of the plurality of steps, the electronic instructions including at least graphical information to be displayed through the student user interface unit for each step of the plurality of steps;
automatically provision, to the student user interface unit, one or more remote integrated learning environments having at least the plurality of steps, the one or more remote integrated learning environments provided for use by the one or more students through the student user interface unit, each of the plurality of steps triggering the provisioning of a corresponding state by the student user interface unit;
track, using a timer, one or more elapsed times, each of the elapsed times corresponding to an amount of time the student user interface unit has remained in a corresponding state;
based on the linkages between the steps of the plurality of steps, switch between the steps of the plurality of steps when sufficient indications of progress are received through the student user interface unit, triggering changes of state by the student user interface unit;
provide a series of visual indicators, each of the visual indicators indicative of each step of the plurality of steps;
provide, in a first format, a visual indicator of the series of visual indicators associated with a current step being provided by the student user interface unit; and
provide, in a second format, visual indicators of the series of visual indicators associated with steps already traversed by the student user interface unit.

2. The system of claim 1, the system including a transaction unit, the transaction unit configured to:
receive one or more requests to provision one or more selected remote integrated learning environments from the student user interface unit, each of the one or more selected remote integrated learning environments having a number of available positions;
determine whether there is availability in the one or more selected remote integrated learning environments by determining whether any of the one or more selected remote integrated learning environments has the number of available positions greater than 0;
if the number of available positions is greater than 0 for the one or more selected remote integrated learning environments, receive an indication of payment from the student user interface unit;
cause the provisioning of the selected one or more selected remote integrated learning environments having the number of available positions greater than 0 through the student user interface unit;
generate one or more activation codes, each of the one or more activation codes being adapted to control access to the selected one or more remote integrated learning environments being provisioned;
decrement the number of available positions for each of the one or more provisioned remote integrated learning environments by one;
cause a first electronic payment to be provided to a service provider, the first electronic payment transferring funds corresponding to a first portion of the received payment; and
cause a second electronic payment to be provided to a content provider, the second electronic payment transferring funds corresponding to a second portion of the received payment.

3. The system of claim 1, the set of instructions further adapted to cause the one or more processors to automatically provision one or more remote integrated learning environments includes instructions to receive, from the second set of remote computing systems being utilized by the one or more students, one or more sets of textual information, each set of textual information associated with a corresponding step, and wherein the system further includes a report creation unit configured to automatically generate a textual report collating the one or more sets of textual information, the one or more sets organized by step.

4. The system of claim 1, wherein the linkages provide a non-linear progression through the plurality of steps.

5. The system of claim 1, wherein the student user interface unit is configured to provide just-in-time help through the student user interface unit.

6. The system of claim 5, wherein the just-in-time help is provided when the student user interface unit receives a request for help.

7. The system of claim 5, wherein the just-in-time help is provided through the administrative interface unit.

8. The system of claim 5, wherein the just-in-time help is provided when the student user interface unit determines that the student user interface unit has remained in a state beyond a pre-defined threshold of time.

9. The system of claim 1, the system including an automated grading unit, the automated grading unit configured to:
receive an electronic instruction from the administrative interface unit to generate one or more grade reports;
automatically generate the one or more grade reports, each of the grade reports including grades based at least on the one or more elapsed times corresponding to the amount of time the student user interface unit has remained in a corresponding state;
provide the one or more grade reports through the administrative interface unit; and
provide the one or more grade reports through the student user interface unit.

10. The system of claim 9, wherein the automated grading unit is further configured to track indications of progress across an aggregate of students; and wherein the grades included in the grade reports are based at least on a comparison of (i) the indications of progress across the aggregate of students and (ii) the indications of progress received through the student user interface unit for a particular student.

11. A method for administering one or more remote integrated learning environments, on a system having one or more processors, the method comprising:
providing an administrative interface unit configured for communication with a first set of remote computing systems being utilized by one or more administrators;
providing a student user interface unit configured for communication with a second set of remote computing systems being utilized by one or more students;
providing an integrated learning environment unit configured to interoperate with the administrative interface unit and the student user interface unit;
receiving, electronic instructions representative of learning materials from the administrative interface unit;
automatically parsing the electronic instructions to extract a plurality of steps to be performed by the one or more students, each step of the plurality of steps having linkages to at least one other step, the linkages indicating progression between the steps of the plurality of steps, the electronic instructions including at least graphical information to be displayed through the student user interface unit for each step of the plurality of steps;
automatically provisioning, to the student user interface unit, one or more remote integrated learning environments having at least the plurality of steps, the one or more remote integrated learning environments provided for use by the one or more students through the student user interface unit, each of the plurality of steps triggering the provisioning of a corresponding state by the student user interface unit;
tracking, using a timer, one or more elapsed times, each of the elapsed times corresponding to an amount of time the student user interface unit has remained in a corresponding state;
based on the linkages between the steps of the plurality of steps, switching between the steps of the plurality of steps when sufficient indications of progress are received through the student user interface unit, triggering changes of state by the student user interface unit;
providing a series of visual indicators, each of the visual indicators indicative of each step of the plurality of steps;
providing, in a first format, a visual indicator of the series of visual indicators associated with a current step being provided by the student user interface unit; and
providing, in a second format, visual indicators of the series of visual indicators associated with steps already traversed by the student user interface unit.

12. The method of claim 11, the system further including a transaction unit, the transaction unit configured for performing steps of:
receiving one or more requests to provision one or more selected remote integrated learning environments from the student user interface unit, each of the one or more selected remote integrated learning environments having a number of available positions;
determining whether there is availability in the one or more selected remote integrated learning environments by determining whether any of the one or more selected remote integrated learning environments has the number of available positions greater than 0;
if the number of available positions greater is than 0 for the one or more selected remote integrated learning environments, receive an indication of payment from the student user interface unit;
causing the provisioning of the selected one or more selected remote integrated learning environments having the number of available positions greater than 0 through the student user interface unit;
generating one or more activation codes, each of the one or more activation codes being adapted to control access to the selected one or more remote integrated learning environments being provisioned;
decrementing the number of available positions for each of the one or more provisioned remote integrated learning environments by one;
causing a first electronic payment to be provided to a service provider, the first electronic payment transferring funds corresponding to a first portion of the received payment; and
causing a second electronic payment to be provided to a content provider, the second electronic payment transferring funds corresponding to a second portion of the received payment.

13. The method of claim 11, further including receiving, from the second set of remote computing systems being utilized by the one or more students, one or more sets of textual information, each set of textual information associated with a corresponding step, and wherein the system further includes a report creation unit configured for automatically generating a textual report collating the one or more sets of textual information, the one or more sets organized by step.

14. The method of claim 11, wherein the linkages provide a non-linear progression through the plurality of steps.

15. The method of claim 11, wherein the student user interface unit is configured to provide just-in-time help through the student user interface unit.

16. The method of claim 15, wherein the just-in-time help is provided when the student user interface unit receives a request for help.

17. The method of claim 15, wherein the just-in-time help is provided through the administrative interface unit.

18. The method of claim 15, wherein the just-in-time help is provided when the student user interface unit determines that the student user interface unit has remained in a state beyond a pre-defined threshold of time.

19. The method of claim 11, the system further including an automated grading unit, the automated grading unit configured for performing steps including:
receiving an electronic instruction from the administrative interface unit to generate one or more grade reports;
automatically generating the one or more grade reports, each of the grade reports including grades based at least on the one or more elapsed times corresponding to the amount of time the student user interface unit has remained in a corresponding state;
providing the one or more grade reports through the administrative interface unit; and
providing the one or more grade reports through the student user interface unit.

20. The method of claim 19, wherein the automated grading unit is further configured to perform steps including:
tracking indications of progress across an aggregate of students; and
wherein the grades included in the grade reports are based at least on a comparison of (i) the indications of progress across the aggregate of students and (ii) the indications of progress received through the student user interface unit for a particular student.
